(19) United States
(12) Patent Application Publication
(10) Pub. No.: US 2012/0135331 A1
(43) Pub. Date: May 31, 2012

(54) CATHODE

(75) Inventors: Matthew Rosseinsky, Heswall (GB); Hongjun Niu, Kirkby (GB); John Claridge, Liverpool (GB); Jared Smit, Lafayette, IN (US); Zengqiang Deng, Liazbou (CN)

(73) Assignee: The University of Liverpool, Liverpool, Merseyside (GB)

(21) Appl. No.: 13/322,267

(22) PCT Filed: May 28, 2010
(86) PCT No.: PCT/GB10/50907

§ 371 Date: Feb. 1, 2012

(30) Foreign Application Priority Data
May 28, 2009 (GB) 0909134.9

(51) Int. Cl. H01M 4/90; H01M 8/12

(52) U.S. Cl. 429/482; 252/182.1; 252/519.15

(57) ABSTRACT

The present invention relates to a cathode composed of a perovskite-type or fluorite-type mixed metal oxide containing molybdenum, to a composite comprising the mixed metal oxide and to a solid oxide fuel cell comprising the cathode. The cathode mixed metal oxide has an empirical formula unit: EaTbMocOn wherein: T is one or more transition metal elements other than Mo; E is one or more metal elements selected from the group consisting of lanthanide metal elements, alkali metal elements, alkaline earth metal elements, Pb and Bi; and a, b, c, and n are non-zero numerals which may be the same or different for each element.

The present invention relates to a cathode composed of a mixed metal oxide, to a composite comprising the mixed metal oxide and to a solid oxide fuel cell comprising the cathode.

With increasing demand for clean and renewable energy, solid-oxide fuel cells (SOFCs) have received great attention owing to high energy efficiency, environmental friendliness and excellent fuel flexibility. To make SOFCs economically competitive with existing technology, an intermediate operating temperature of 500° C. to 750° C. or low-temperature (<600° C.) is desirable (see Steele, B. C. H.; Heinzel, A. Nature 2001, 414, 345; Vohs, J. M.; Gorte, R. J. Adv. Mater. 2009, 21, 1; and Yang, L et al. Adv. Mater. 2008, 20, 3280). Although such temperatures offer improved durability (ie reduce the likelihood of cracks upon thermal cycling and inter-diffusion), lower fabrication costs and use of cheaper metals (for sealing and interconnect), it is challenging at such temperatures due to a lack of appropriate materials for SOFC components. To compensate for the significant increase in electrolyte and electrode ohmic and polarization losses at such temperatures, electrolyte with higher ionic conductivity and/or decreased thickness (such as Gd³⁺ or Sm³⁺ doped CeO₂, Sr²⁺ and Mg²⁺ doped LaGaO₃ (LSGM)) is used. The anode may be a cermet with Ni and YSZ or doped CeO₂. However the largest contributor to the total resistance at these operating temperatures is cathodic polarization resistance which makes the development of new cathode materials critical for the commercialization of SOFCs (see Ivers-Tiffee, E et al. J. Eur Ceram. Soc. 2001, 21, 1805). With a target power density of 1 Wcm⁻², the combined area-specific resistance (ASR) of the cell components (electrolyte, anode and cathode) needs to be below 0.3 Ωcm² and ideally approach 0.1 Ωcm².

Early SOFC cathodes encompass perovskite-type and related structures. For example, La₁₋ₓSrₓMnO_{3-δ} is the present choice of cathode for zirconia electrolyte-based SOFCs that operate efficiently at high temperatures (usually above 700° C.). Ln₁₋ₓSrₓCoO_{3-δ}, La₁₋ₓSrₓCo_{1-y}Fe_{y}O_{3-δ} and Ba_{0.5}Sr_{0.5}Co_{0.8}Fe_{0.2}O_{3-δ} have performed promisingly with ceria electrolytes at an intermediate temperature range (see Shao, Z. P.; Haile, S. M. Nature 2004, 431,170; Xia, C. R. et al. Solid State Ionics 2002, 149, 11; and Stevenson, J. W. et al. J. Electrochem. Soc. 1996, 143, 2722). Other cathode materials include LnBaCo₂O_{5+δ} (where Ln is Gd, Pr) with ordered A-site cations in the perovskite structure and La₂NiO_{4+δ} and LaSr₃(Fe, Co)₃O_{10-δ} with a Ruddlesden-Popper (RP) structure (see Lee, K. T.; Manthiram, A. Chem. Mater. 2006, 18, 1621; and Tarancon, A. et al. A. J. Mater. Chem. 2007, 17, 3175).

Cobalt is often included in mixed-conducting perovskite oxides owing to high electronic conductivity and loose bonding with oxide-ion (which possibly facilitates the production of oxygen vacancies and thereby ionic conductivity at high temperatures). Cobaltites have a limited structural stability over a narrow temperature range and pO₂ range owing to fluctuations in the ionic radius, oxidation and spin states of cobalt (II), (III) and (IV). For example, some of these materials show very promising performance as oxygen permeation membranes or SOFCs cathodes during short term operation but rapid degradation over time. This is an indication of limited stability which is a particular concern for practical application. Furthermore, ordering of oxygen vacancies has been demonstrated to occur in Ln₁₋ₓSrₓCoO_{3-δ} and SrCO_{0.8}Fe_{0.2}O_{3-δ} below 750° C. and with pO₂ less than 0.1 atm to yield an orthorhombic brownmillerite phase (see Kruidhof, H et al. J. Solid State Ionics 1993, 63-65, 816; Deng, Z. Q et al.; J. Solid State Chem. 2006, 179, 362; and Harrison, W. T. A et al. Mater. Res. Bull. 1995, 30, 621). Phase transition between the vacancy-disordered perovskite and the vacancy ordered brownmillerite causes a significant decrease in electronic and ionic conductivity, together with mechanical instability associated with lattice expansion. Partial substitution of Ba for Sr suppresses this type of transition. Indeed Ba_{0.5}Sr_{0.5}Co_{0.8}Fe_{0.2}O_{3-δ} has been reported among the most promising oxygen permeable membrane and SOFC cathode materials (see Zhao [supra]). However, recent studies have shown that the former single cubic perovskite phase undergoes decomposition into a hexagonal perovskite structure and a cubic perovskite at intermediate temperatures over time thereby rendering the long-term stability as SOFC cathode materials questionable (see Svarcova, S et al. Solid State Ionics 2008, 178, 1787).

Interfacial reaction between cathode and electrolyte is another concern for cathode performance. Formation of undesirable impurity phases at high temperature during fabrication and operation may be detrimental to cathode applications. There has been little attention paid to the perovskite related structure with ordered B-site cations. Some molybdenum compounds are well known catalysts with high activity for selective oxidation of hydrocarbons (see Stern, D. L; Grasselli, R. K. Journal of Catalysis 1997, 167, 550; Yoon, Y. S. et al. Topics in Catalysis 1996, 3, 265). Niobium substitution has been found effective to stabilize the high-oxygen permeable perovskite structure in strontium cobaltite (see Nagai, T et al. Solid State Ionics 2007, 177, 3433).

The present invention is based on the recognition that the presence of molybdenum in a perovskite-type or fluorite-type mixed metal oxide may serve to promote stability and retain activity in spite of a reduction in ionic conductivity.

Viewed from a first aspect the present invention provides a cathode composed of a mixed metal oxide exhibiting perovskite-type and/or fluorite-type structural characteristics which has an empirical formula unit:

E_{A}T_{B}Mo_{C}Oₙ

wherein:

T is one or more transition metal elements other than Mo;

E is one or more metal elements selected from the group consisting of lanthanide metal elements, alkali metal elements, alkaline earth metal elements, Pb and Bi; and

A, B, C and n are non-zero numerals which may be the same or different for each element.

The cathode of the invention has advantageous properties which may include compatibility of the mixed metal oxide with solid fuel cell electrolytes and desirable electrochemical properties such as low electrical resistance exhibited by the mixed metal oxide (eg at intermediate temperatures). The presence of molybdenum may serve to promote the oxygen reduction reaction or suppress phase transitions at elevated temperature.

Preferably the cathode is electron conducting. Preferably the cathode is oxide ion conducting.

Preferably the total number of metal elements E and T is 3 or more. Particularly preferably at least one of E and T is a pair of metal elements.

Mo may occupy tetrahedral or octahedral sites where it may be ordered or disordered. Preferably Mo predominantly occupies octahedral sites (where it is ordered).

The lanthanide metal elements may be Th, Ce, Nd, La, Sm, Gd, Y, Pr or Eu, preferably La, Sm, Nd, Gd, Pr or Eu, particularly preferably La, Sm, Nd or Gd

The alkaline earth metal elements may be Ca, Ba or Sr.

The one or more transition metal elements other than molybdenum may be selected from the group consisting of the 3d transition metal elements and the 4d transition metal elements, preferably the group consisting of the 3d transition metal elements and Nb, particularly preferably the group consisting of Ni, Co, V, Nb, Mn and Fe.

Each of A, B, C and n may be an integer or a non-integer which is the same or different for each element. Preferably n is a non-integer (ie oxygen present in the mixed metal oxide is non-stoichiometric). For example, the mixed metal oxide may be oxygen deficient (eg exhibit oxygen vacancies or defects). Typically n≦15.

The perovskite-type structural characteristics may be attributable to a perovskite structure, a double perovskite structure, a perovskite superstructure, a Ruddlesden-Popper structure or a brownmillerite structure. Preferably the perovskite-type structural characteristics are attributable to a perovskite or double perovskite structure.

The fluorite-type structural characteristics may be attributable to a fluorite structure or a pyrochlore structure.

In a preferred embodiment, the mixed metal oxide exhibits perovskite-type structural characteristics.

The structure of the mixed metal oxide may be an intergrowth structure (eg a layer, block or slab intergrowth structure). The intergrowth structure may be a partial, substantially ordered or disordered intergrowth structure.

The mixed metal oxide may additionally exhibit rock salt-type structural characteristics.

In a first preferred embodiment, the mixed metal oxide has an empirical formula unit:

(E′_{A′}E″_{A″})T_{B}Mo_{C}Oₙ

wherein
E′ is Ba, Sr or a lanthanide metal element;
E″ is Ba, Ca or Sr;
T is one or more transition metal elements selected from the group consisting of Co, Nb, Mn, V, Fe and Ni; and
A′, A″, B, C and n are non-zero numerals which may be the same or different for each element.

Particularly preferably E′ is a lanthanide metal element (preferably selected from the group consisting of La, Nd, Gd and Sm). Particularly preferably E″ is Sr. More preferably E′ is La and E″ is Sr.

Particularly preferably T is Co (optionally together with Fe and/or Nb). Preferably in the first embodiment, the mixed metal oxide has a structural unit of formula:

(E′₁₋ₓE″ₓ)(T_{1-y-v}Fe_{y-z})Mo_{v+z}O_{3-δ}

wherein:
0<x<1;
0≦y≦1;
0<v+z<1;
E′ is Ba or a lanthanide metal element;
E″ is Sr or Ca; and
T is one or more transition metal elements selected from the group consisting of Co, V or Mn.

Particularly preferably y is 0. Particularly preferably z is 0. Particularly preferably T is Co or Mn. More preferably T is Co. Particularly preferably E′ is La.

Particularly preferably the mixed metal oxide has a structural unit of formula:

(Ba₁₋ₓSrₓ)(Co_{1-y-v}Fe_{y-z})Mo_{v+z} O_{3-δ}

wherein:
0<x<1;
0.2≦y≦0.4;
0.05≦v+z≦0.5.

More preferably x is 0.5.

More preferably 0.125≦v+z≦0.375.

Preferably in the first embodiment, the mixed metal oxide has a structural unit of formula:

LaSr₃((Co_{1-y-v}Fe_{y-z})(Mo₁₋ₓNbₓ)_{v+z})₃O_{10-δ}

wherein:
0≦y≦1;
0≦x<1; and
0<v+z<1.

In a second preferred embodiment, the mixed metal oxide has a structural unit of formula:

(E′₂₋ₓEₓ)T_{1-z}Mo_{z}O_{4+δ}

wherein:
0≦x≦1;
0<z<1;
E′ is a lanthanide metal element; and
E″ is Sr or Ba.

Particularly preferably T is one or more transition metal elements selected from the group consisting of Ni or Cu. More preferably T is Ni.

Particularly preferably E′ is La.

In a third preferred embodiment, the mixed metal oxide has a structural unit of formula:

(E′_{A′}E″_{A″})(Co_{1-z}(Mo_{1-y}Nb_{y})_{z})₂O_{5+δ}

wherein:
0<z<1;
0≦y<1;
A′ and A″ are non-zero numerals which may be the same or different for each element;
E′ is a lanthanide metal element; and
E″ is Ba, Ca, Sr or a lanthanide metal element.

Particularly preferably E″ is Ba.

Particularly preferably the mixed metal oxide is a phase in the solid solution series (NdBaCo₂O₅)ₓ—(Ba₂CoMo_{0.5}Nb_{0.5}O₆)₁₋ₓ.

In a fourth preferred embodiment, the mixed metal oxide exhibits perovskite-type structural characteristics in which Mo occupies tetrahedral sites.

Particularly preferably the mixed metal oxide in which Mo occupies tetrahedral sites is a brownmillerite structure. More preferably the mixed metal oxide has a structural unit of formula:

E₂(T_{1-z}Mo_{z})₂O₅

wherein:
0<z<1;
E is one or more elements selected from the group consisting of lanthanide metal elements, Sr, Ca and Ba; and
T is one or more of the group consisting of Fe and Co.

Even more preferably the mixed metal oxide is a phase in the solid solution series (Ca₂Fe₂O₅)₁₋ₓ—(Ba₂CoMoO₆)ₓ.

Particularly preferably the mixed metal oxide in which Mo occupies tetrahedral sites is a perovskite superstructure. Particularly preferably the mixed metal oxide is NdCa₂Ba₂(Co_{3/4}Mo_{1/4})Co₂Fe₂O₁₃.

In a fifth preferred embodiment, the mixed metal oxide has a structural unit of formula:

(E′₂₋ₓE″ₓ)(Co_{1-z}(Mo_{1-y}Nb_{y})_{z})₂O_{6-δ}

wherein:
0≦x≦1;
0≦y<1;
0<z<1;
E′ is Sr or Ba; and
E″ is a lanthanide metal element.

Particularly preferably y is 0.5. Particularly preferably x is zero. Particularly preferably E′ is Ba.

In this embodiment, it is advantageous that Mo is thought to withstand any tendency for Co to oxidise and adopt a less desirable lattice position.

In a sixth preferred embodiment, the mixed metal oxide has a structural unit of formula:

Sr₄(Fe_{1-x-z}Coₓ(Mo_{1-y}Nb_{y})_{z})₆O₁₃

wherein:
0≦z≦1;
0≦y≦1; and
0≦x≦1.

Particularly preferably the mixed metal oxide is a phase in the solid solution series (Sr₄Fe₆O₁₃)ₓ—(Ba₂CoMo_{0.5}Nb_{0.5}O₆)₁₋ₓ.

In a further preferred embodiment, the mixed metal oxide exhibits fluorite-type structural characteristics. Particularly preferably the fluorite-type structural characteristics are attributable to a fluorite or pyrochlore structure. Particularly preferably Mo predominantly occupies octahedral cation sites in the fluorite-type structure.

In a preferred embodiment, the mixed metal oxide is a Mo-doped cobaltite oxide (for example a Mo-doped cobaltite ferrite oxide or cobaltite niobate oxide) in which the perovskite-type structural characteristics are attributable to a perovskite or double perovskite structure. Particularly preferably the mixed metal oxide is a Mo-doped cobaltite ferrite oxide in which the perovskite-type structural characteristics are attributable to a perovskite or double perovskite structure. More preferably the mixed metal oxide is a barium-strontium cobaltite ferrite oxide in which the perovskite-type structural characteristics are attributable to a perovskite or double perovskite structure.

Specifically preferred examples of mixed metal oxide cathodes according to the invention are one or more of the following:

molybdenum-substituted La₁₋ₓSrₓMnO_{3-δ} (wherein 0<x<1, preferably x is 0.2);

molybdenum-substituted Ln₁₋ₓSrₓCoO_{3-δ} (wherein 0<x<1 and Ln is a lanthanide element, preferably Ln is La and x is 0.4 or Ln is Sm and x is 0.5);

molybdenum-substituted La₁₋ₓSrₓCo_{1-y}Fe_{y}O_{3-δ} (wherein 0<x<1, preferably x=0.4 and y=0.8);

molybdenum-substituted Ba_{3.5}Sr_{0.5}Co_{0.8}Fe_{0.2}O_{3-δ} or Ba_{0.5}Sr_{0.5}Co_{0.6}Fe_{0.4}O_{3-δ} (preferably Ba_{0.5}Sr_{0.5}Co_{0.8}Fe_{co}Mo_{0.1}O_{3-δ}, Ba_{0.5}Sr_{0.5}Co_{0.5}Fe_{0.125}Mo_{0.375}O_{3-δ}; Ba_{0.5}Sr_{0.5}Co_{0.7}Fe_{0.175}Mo_{0.125}O_{3-δ}, Ba_{0.5}Sr_{0.5}Co_{0.6}Fe_{0.1}Mo_{0.2}O_{3-δ}, Ba_{0.5}Sr_{0.5}Co_{0.48}Fe_{0.32}Mo_{0.2}O_{3-δ} and Ba_{0.5}Sr_{0.5}Co_{0.6}Fe_{0.1}Mo_{0.3}O_{3-δ});

Ba₂CoMo_{0.5}Nb_{0.5}O_{6-δ};

molybdenum-substituted LnBaCo₂O₅₊ₓ (where Ln is a lanthanide element, preferably Nd);

LaSrNi₁₋ₓMoₓO_{4+δ};

LaSr₃(Fe, Co, Nb, Mo)₃O_{10-δ};

NdCa₂Ba₂(Co_{3/4}Mo_{1/4})Co₂Fe₂O₁₃;

molybdenum-substituted Ca₂Fe₂O₅;

molybdenum-substituted Sr₄Fe_{6-y}Co_{y}O₁₃ (where 0≦y≦6); and

molybdenum-substituted La_{0.74}Ca_{0.25}Co_{0.8}Fe_{0.2}O_{3-δ}.

More specifically preferred are one or more of the group consisting of Ba₂CoMo_{0.5}Nb_{0.5}O_{6-δ}, Ba_{0.5}Sr_{0.5}Co_{0.8}Fe_{0.1}Mo_{0.1}O_{3-δ}, Ba_{0.5}Sr_{0.5}Co_{0.5}Fe_{0.125}Mo_{0.375}O_{3-δ}, Ba_{0.5}Sr_{0.5}Co_{0.7}Fe_{0.175}Mo_{0.125}O_{3-δ}, Ba_{0.5}Sr_{0.5}Co_{0.7}Fe_{0.1}Mo_{0.2}O_{3-δ}, Ba_{0.5}Sr_{0.5}Co_{0.48}Fe_{0.32}Mo_{0.2}O_{3-δ} and Ba_{0.5}Sr_{0.5}Co_{0.6}Fe_{0.1}Mo_{0.3}O_{3-δ}.

The mixed metal oxides of the invention may be prepared by high temperature solid-state reaction of constituent metals in compound form (eg metal oxides, hydroxides, nitrates or carbonates) or of metal precursors formed by wet chemistry (eg sol-gel synthesis or metal co-precipitation). The mixed metal oxides of the invention may be prepared by hydrothermal synthesis, combustion, freeze drying, aerosol techniques or spray drying.

The mixed metal oxides of the invention may be in bulk or thin film form. Thin films may be prepared by pulsed laser deposition, chemical vapour deposition, chemical solution deposition, atomic layer deposition, sputtering or physical vapour deposition.

The mixed metal oxide may be present in a single or multiple phase system (eg a binary or ternary phase system). Preferably the mixed metal oxide is present in a substantially monophasic system.

Viewed from a further aspect the present invention provides a composition comprising:
a mixed metal oxide as hereinbefore defined; and
an oxide ion or electronic conductivity promoter.

The promoter may be cerium dioxide which is preferably doped (eg lanthanide-doped). Preferred materials are samarium-doped cerium dioxide (eg Ce_{0.8}Sm_{0.2}O_{2-δ}) and gadolinium-doped cerium dioxide (eg Gd_{0.1}Ce_{0.9}O_{1.95}).

The promoter may be an apatite or melilitite compound.

Viewed from a further aspect the present invention provides a composite comprising:
a mixed metal oxide as hereinbefore defined; and
a stabilising ceramic.

The stabilising ceramic may stabilise the mixed metal oxide structurally or reactively. For example, the stabilising ceramic may stabilise the mixed metal oxide against reaction with an electrode in use. Typically the mixed metal oxide is saturated with the stabilising ceramic. The stabilising ceramic may form an intergrowth with the mixed metal oxide.

The stabilising ceramic may be a mixed metal oxide. The stabilising ceramic may be a perovskite. The stabilising ceramic may be Ba₁₋ₓSrₓCeO₃.

Viewed from a still yet further aspect the present invention provides the use of a cathode as hereinbefore defined in a solid oxide fuel cell.

Viewed from an even still yet further aspect the present invention provides a solid oxide fuel cell comprising a cathode as hereinbefore defined, an anode and an oxygen-ion conducting electrolyte.

Typically the electrolyte is a ceramic electrolyte. The electrolyte may be yttria stabilised zirconia, samarium-doped cerium dioxide (eg Ce_{0.8}Sm_{0.2}O_{2-δ}) or gadolinium-doped cerium dioxide (eg Gd_{0.1}Ce_{0.9}O_{1.95}).

The electrolyte may be sandwiched between the anode and cathode. The solid oxide fuel cell may be symmetric or asymmetric. The solid oxide fuel cell may comprise intermediate or buffer layers.

The present invention will now be described in a non-limitative sense with reference to the Examples and accompanying Figures in which:

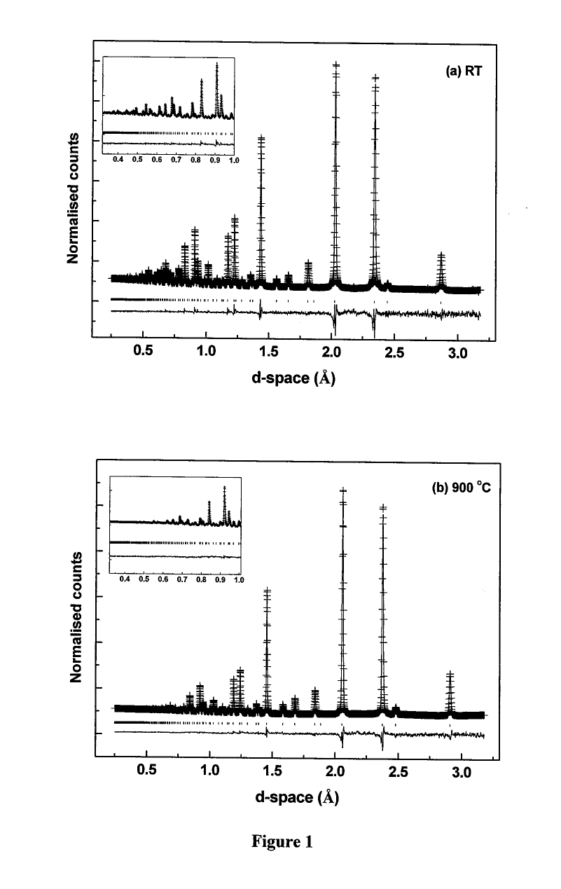

FIG. 1: Rietveld refinement of neutron powder diffraction data at (a) room temperature and (b) 900° C. for Ba₂CoMo_{0.5}Nb_{0.5}O_{6-δ}. The upper tick marks indicate the location of individual Bragg diffraction reflections. The lower curve is the difference plot between the observed and calculated profiles. The inset is a zoom of low d-space values;

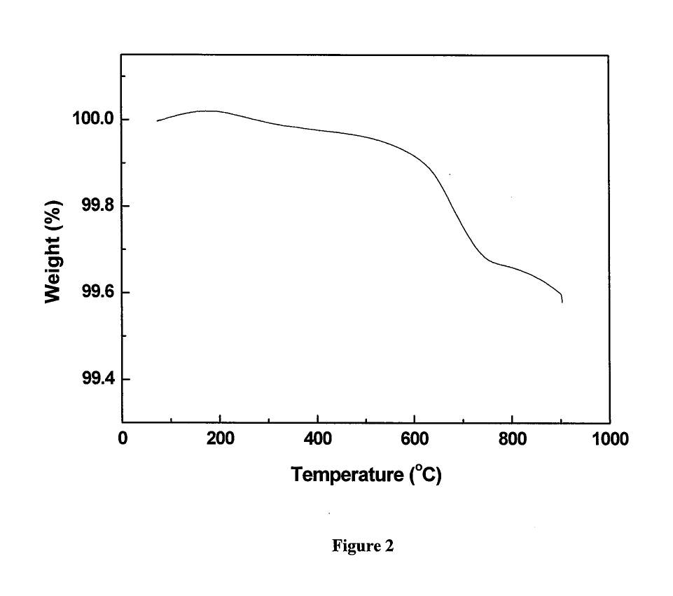

FIG. 2: TGA analysis of as-synthesized Ba₂CoMo_{0.5}Nb_{0.5}O_{6-δ} in air with a heating rate of 5° C./min and dwelling at 900° C. for 0.5 h. A weight loss of ˜0.43% was observed on heating which corresponds to a release of 0.14 oxygen atoms per formula unit;

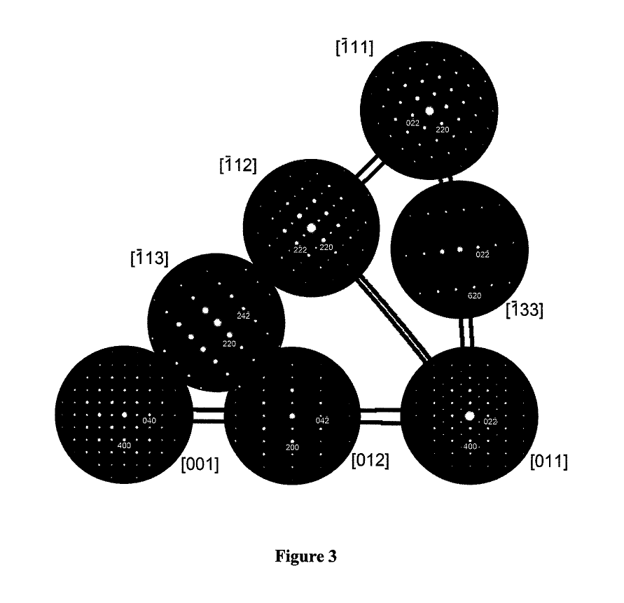

FIG. 3: Composite SAED patterns of [001], [011], [012], [ 1̅11], [ 1̅33], [ 1̅12] and [ 1̅13] zone axes for Ba₂CoMo_{0.5}Nb_{0.5}O_{6-δ}. The diffractions are indexed according to a double perovskite cubic unit cell with lattice parameters a≈8.1 Å and space group Fm 3̅m;

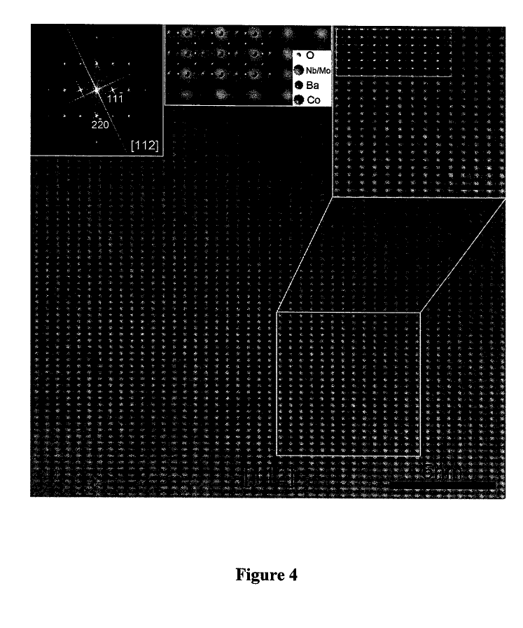

FIG. 4: HRTEM along [112] zone axis for Ba₂CoMo_{0.5}Nb_{0.5}O_{6-δ}. The insets from top left to right are Fast Fourier Transform pattern of the image, schematic drawing of atomic projection according to the HRTEM simulation and details of the framed area with simulated image respectively;

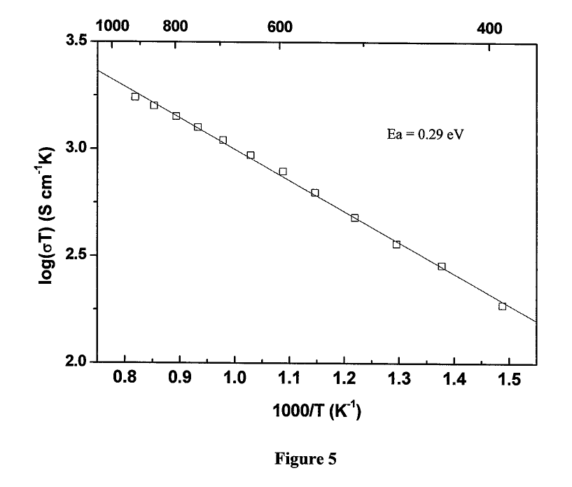

FIG. 5: Temperature dependence of the electrical conductivity of BaCoMo_{0.5}Nb_{0.5}O_{6-δ} samples in air;

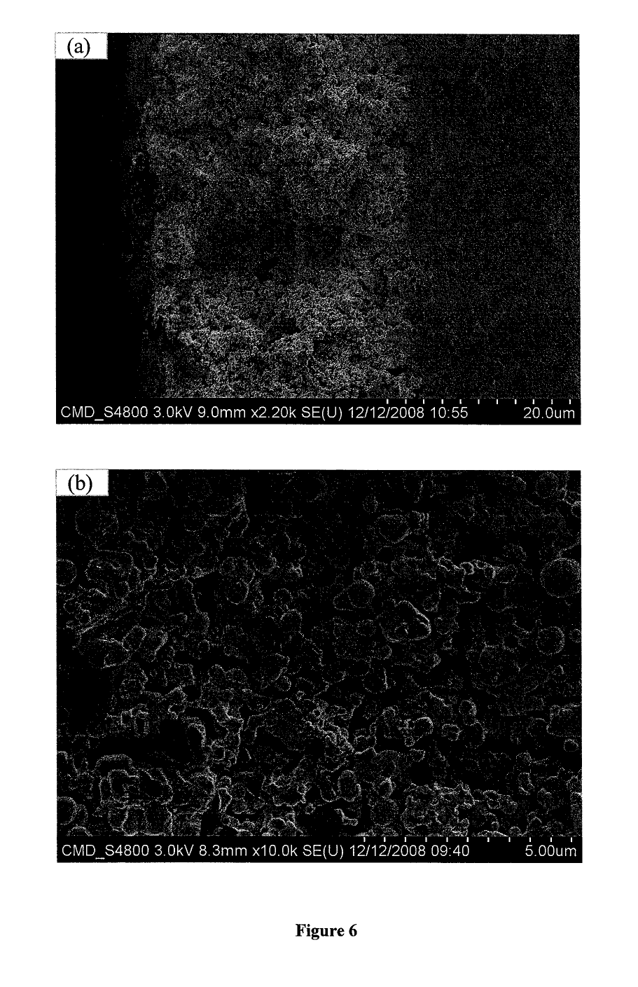

FIG. 6: Cross-sectional (a) and surface (b) views (SEM images) of the BCMN cathode with SDC electrolyte in a symmetrical cell fired at 1000° C./3 h;

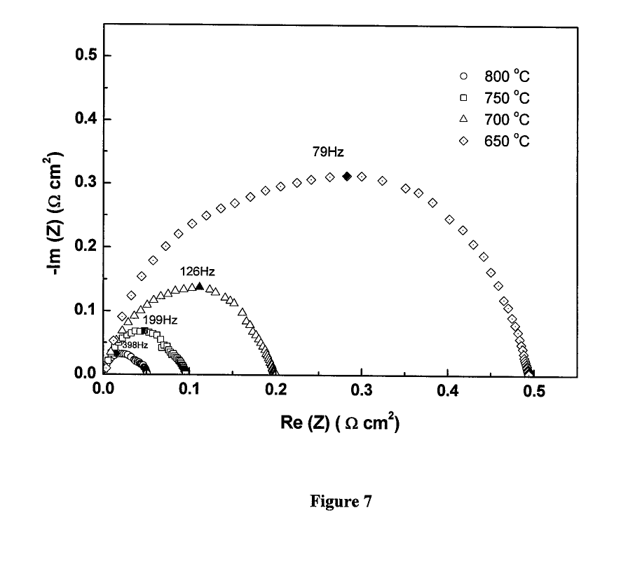

FIG. 7: The cathode polarization of BCMN on a SDC electrolyte symmetric cell measured in air at 800, 750, 700 and 650° C. The electrolyte contribution has been subtracted from the overall impedance;

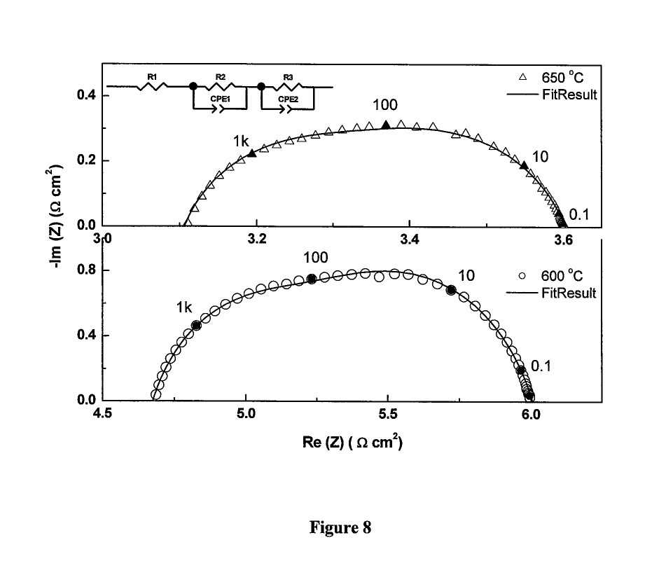

FIG. 8: Fitting the impedance spectra of the BCMN/SDC/BCMN cell at (a) 650° C. and (b) 600° C. to equivalent circuit shown as insert. R₁ is the overall ohmic resistance, R₂ and R₃ correspond respectively to the high and low frequency arcs resistance from electrode and CPE is a constant phase element;

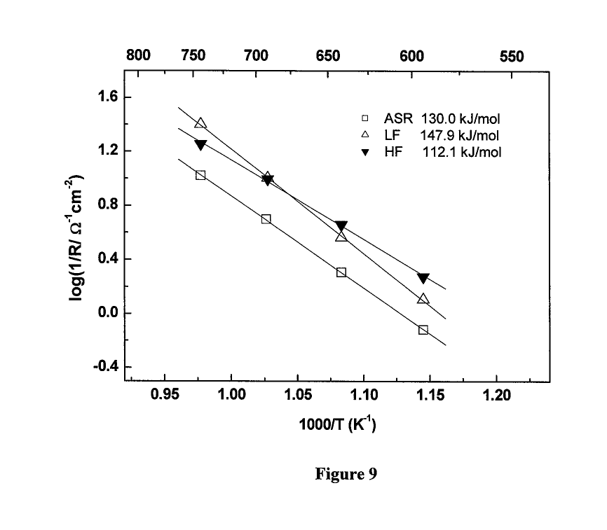

FIG. 9: Activation energy for the high (HF) and low frequency (LF) arcs resistance and total ASR in the temperature range 600-750° C.;

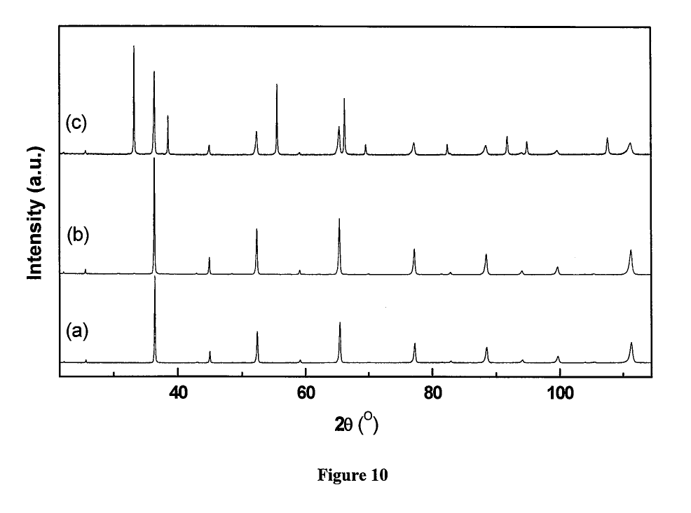

FIG. 10: XRD patterns for BaCoMo_{0.5}Nb_{0.5}O_{6-δ} (a) as-synthesized (1100° C./12 h) and (b) after annealing in air at 750° C./240 h and for (c) BCMN-SDC mixture after co-firing at 1050° C./10 h;

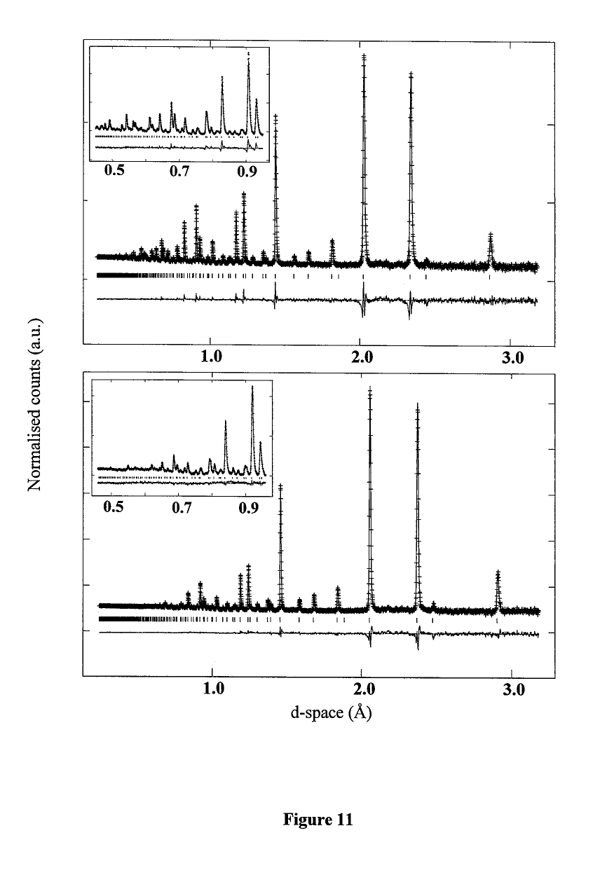

FIG. 11: Rietveld refinement of neutron powder diffraction data from (a, top) room temperature, (b, bottom) 900° C. for Ba₂CoMo_{0.5}Nb_{0.5}O_{6-δ} based on antisite model with Co/(Mo,Nb) total ordering. The upper tick marks indicate the location of individual Bragg diffraction reflections. The lower curve is the difference plot between the observed and calculated profiles;

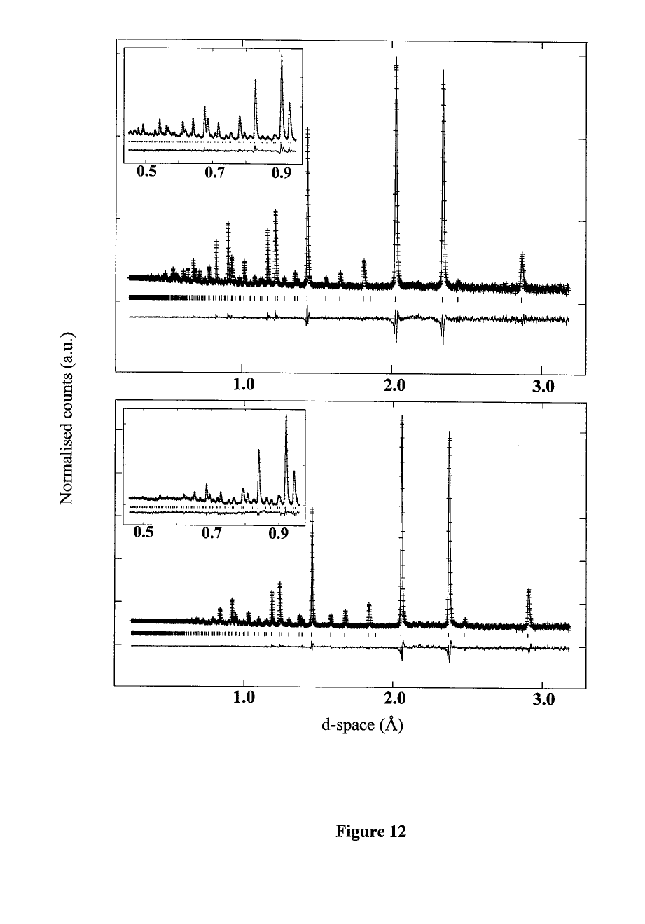

FIG. 12: Rietveld refinement of neutron powder diffraction data from (a, top) room temperature and (b, bottom) 900° C. for Ba₂CoMo_{0.5}Nb_{0.5}O_{6-δ} based on antisite model with Co/Nb antisite. The upper tick marks indicate the location of individual Bragg diffraction reflections. The lower curve is the difference plot between the observed and calculated profiles;

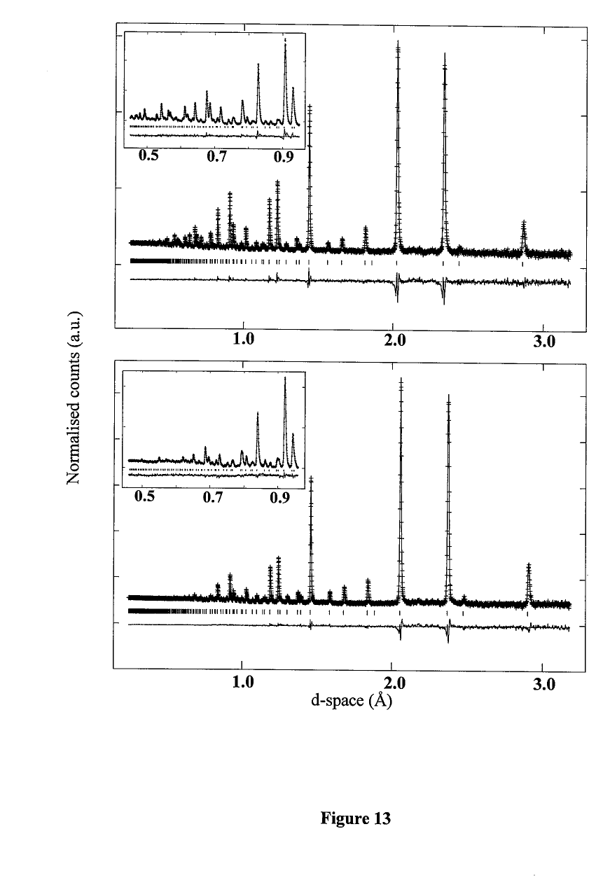

FIG. 13: Rietveld refinement of neutron powder diffraction data from (a, top) room temperature and (b, bottom) 900° C. for Ba₂CoMo_{0.5}Nb_{0.5}O_{6-δ} based on antisite model with Co/Mo antisite. The upper tick marks indicate the location of individual Bragg diffraction reflections. The lower curve is the difference plot between the observed and calculated profiles;

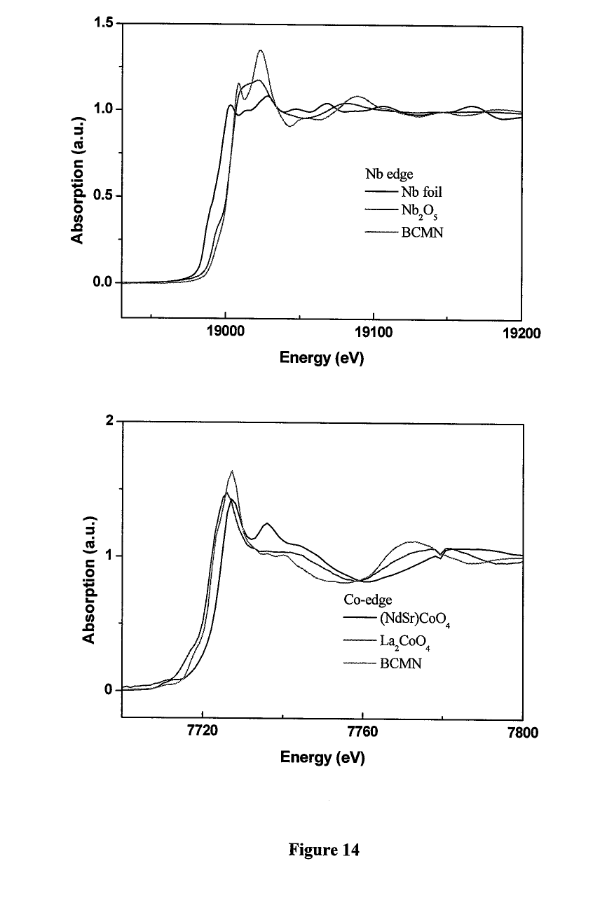

FIG. 14: The XANES spectra of Ba₂CoMo_{0.5}Nb_{0.5}O_{6-δ};

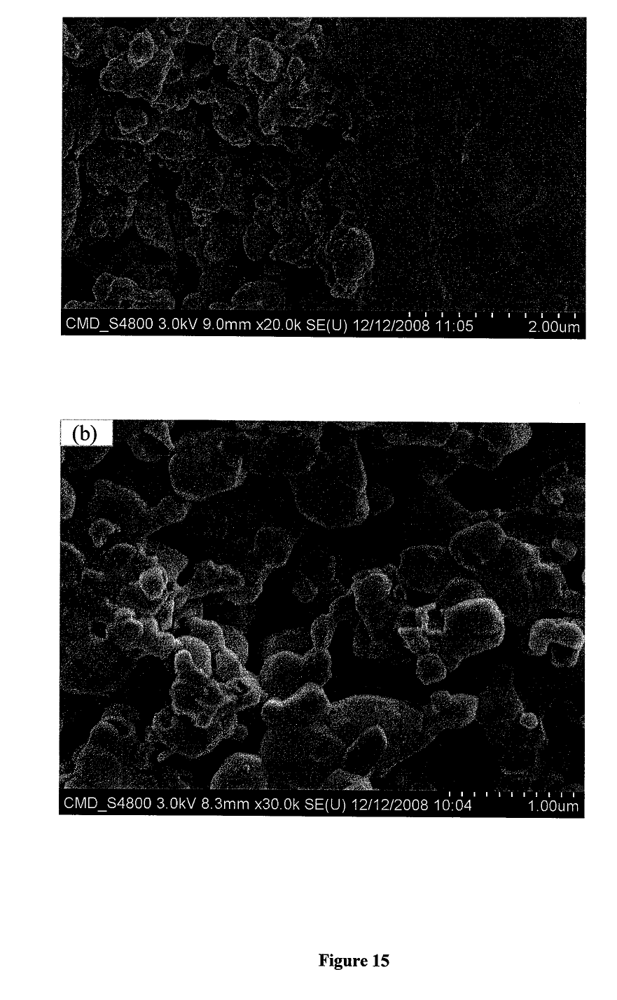

FIG. 15: Cross-sectional views (SEM images) of the BCMN cathode and the interface between SDC electrolyte and the cathode sintered at 1000° C./3 h;

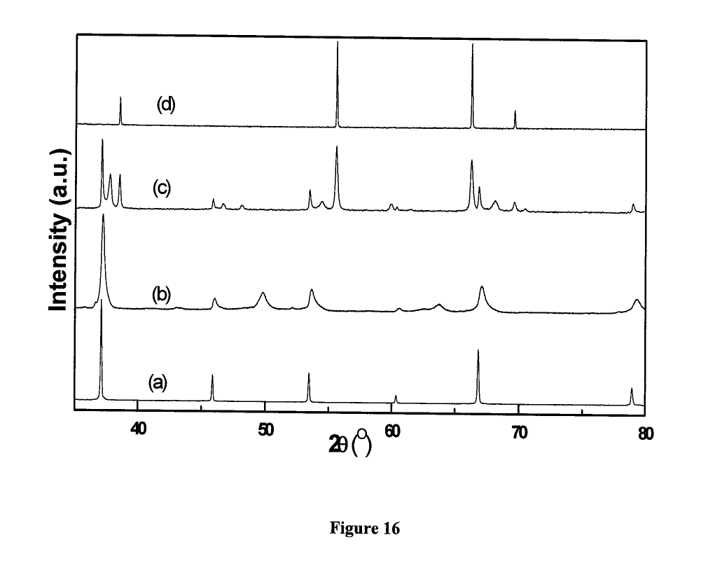

FIG. 16: XRD patterns for Ba_{0.5}Sr_{0.5}Co_{0.8}Fe_{0.2}O_{3-δ} (a) as-synthesized (1100° C./8 h) and (b) after annealing in air at 750° C./240 h and for (c) SDC-SDC mixture after co-firing at 1000° C./5 h and (d) SDC;

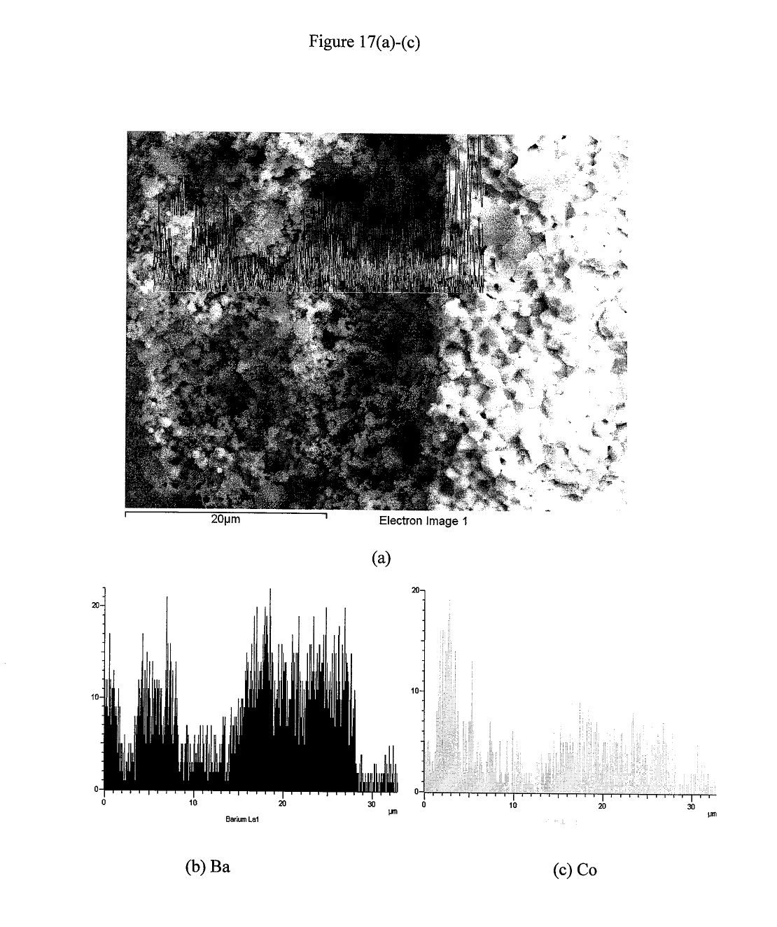

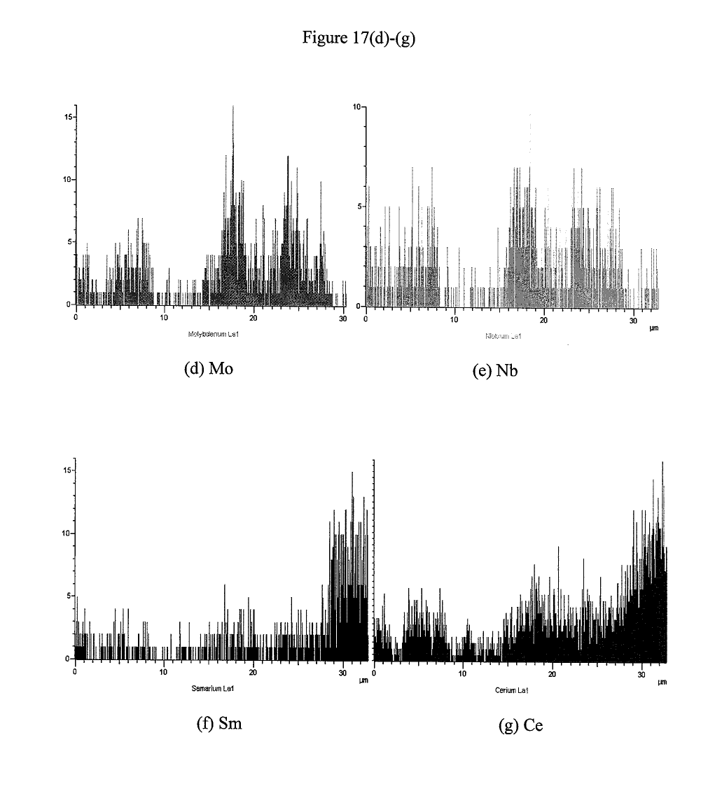

FIG. 17: The BCMN/SDC interface sintered at 1000° C./3 h: SEM (a) and EDS (b-g) analysis of element distribution;

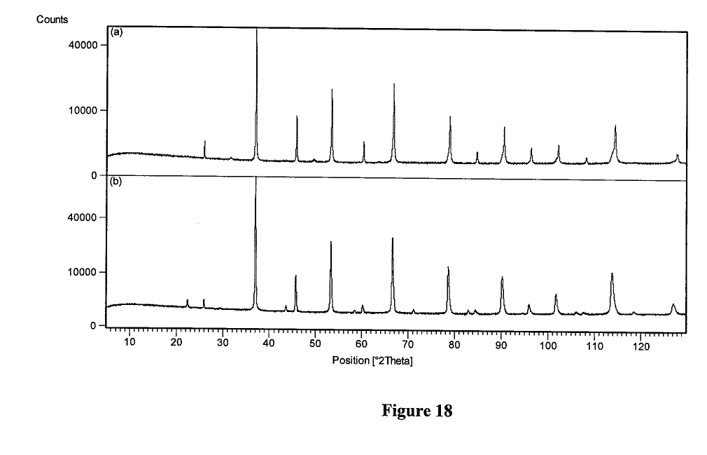

FIG. 18: XRD patterns for (a) BSCF_Mo01 and (b) BSCF_Mo03;

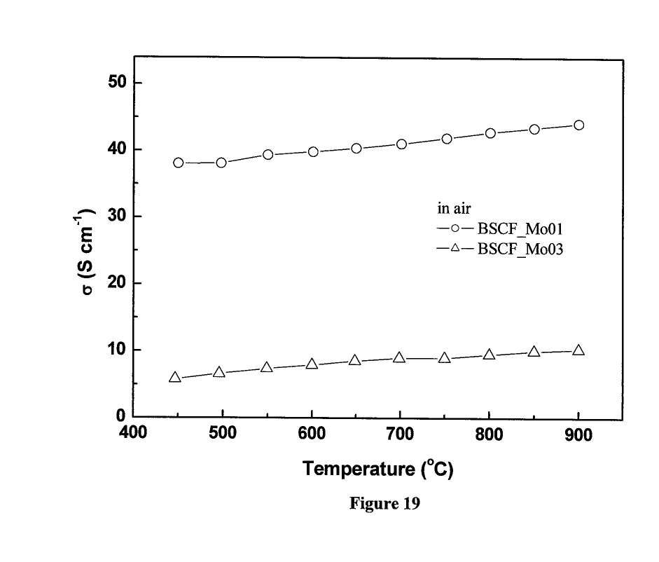

FIG. 19: Temperature dependence of the electrical conductivity of BSCF_Mo01 and BSCF_Mo03 samples in air;

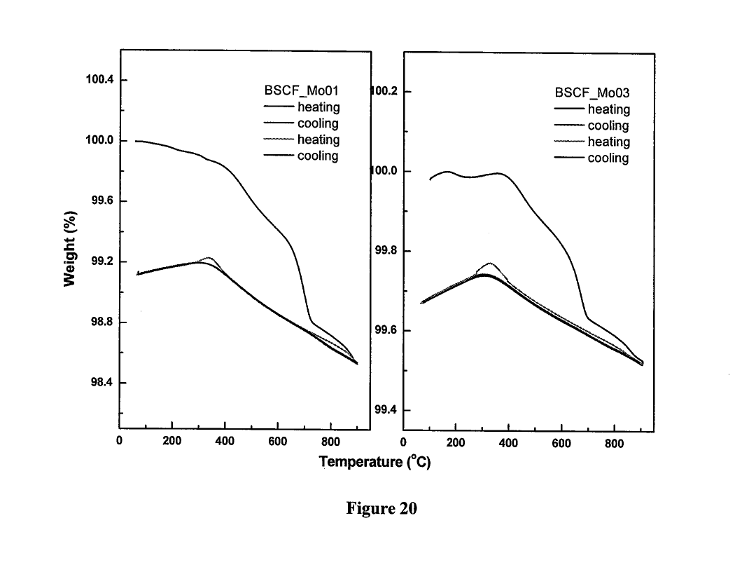

FIG. 20: TGA analysis of as-synthesized BSCF_Mo01 and BSCF_Mo03 in air with a temperature rate 5° C./min for 2 heating-cooling cycles;

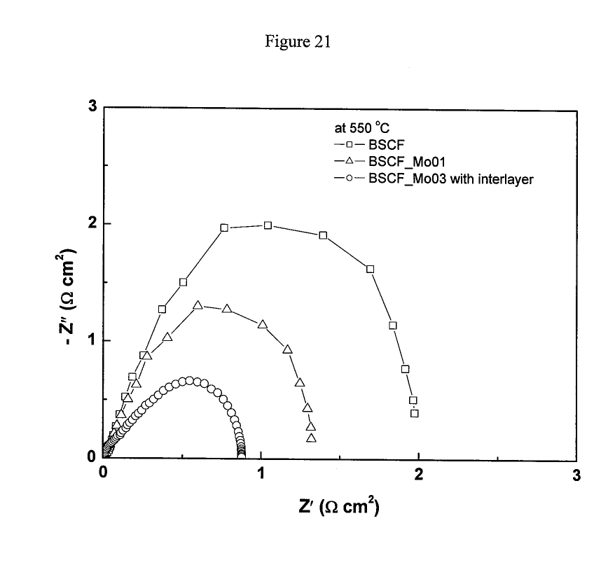

FIG. 21: A comparison of cathode polarization of related materials on SDC electrolyte with symmetric cell configuration measured in air at 550° C. The electrolyte contribution has been subtracted from the overall impedance. Symmetric cells were fired at 1000° C./3 h (except the cell containing BSCF_Mo03 with SDC interlayer which was fired at 950° C./3 h). SDC interlayer was fabricated with screen-printing and fired at 1270° C./1 h before BSCF_Mo03 cathode was printed;

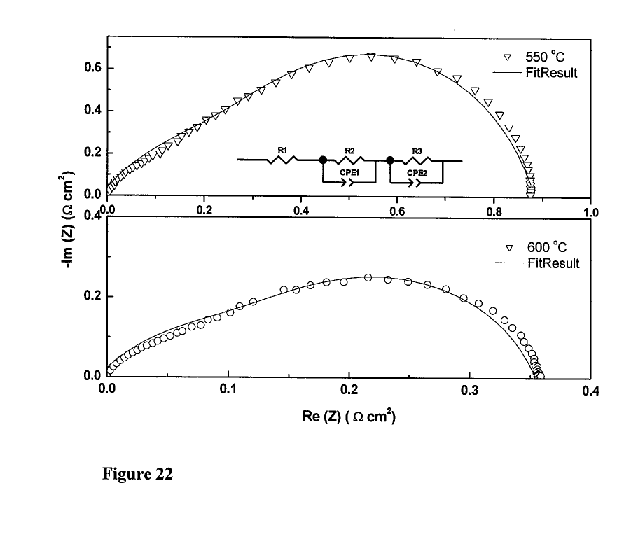

FIG. 22: Fitting the impedance spectra of BSCF_Mo03/SDC/BSCF_Mo03 at 600° C. and 550° C. to equivalent circuit shown as insert. R₁ is the overall ohmic resistance. R₂ and R₃ correspond respectively to the high and low frequency arcs resistance from electrode and CPE is a constant phase element;

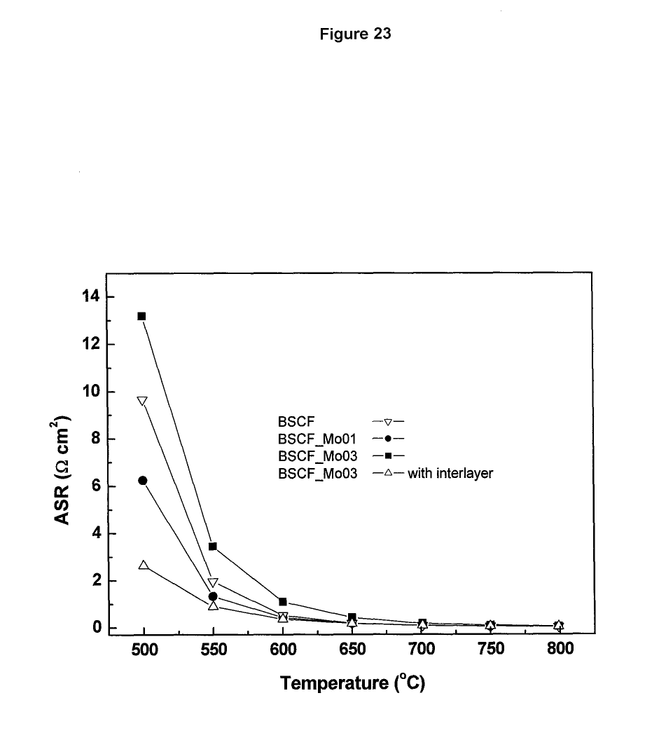

FIG. 23: ASR comparison for BSCF_Mo01, BSCF_Mo03 and BSCF in the temperature range 500° C. to 800° C. The fabrication conditions for symmetric cells are the same as indicated in FIGS. 21 and 22;

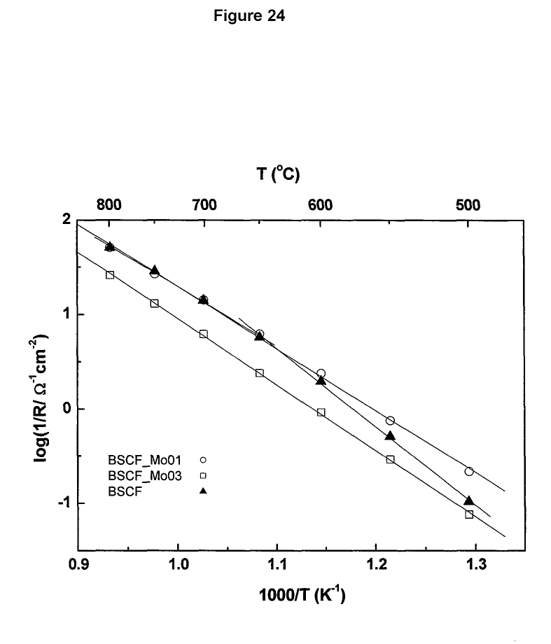

FIG. 24: Activation energy of ASR for BSCF_Mo01, BSCF_Mo03 and BSCF in the temperature range 500° C. to 800° C.;

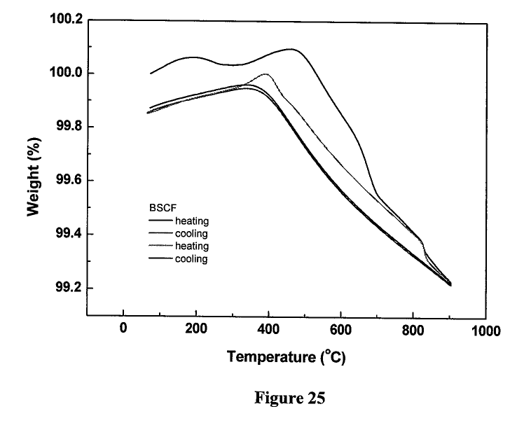

FIG. 25: TGA analysis of as-synthesized BSCF in air with a temperature rate 5° C./min for 2 heating-cooling cycles;

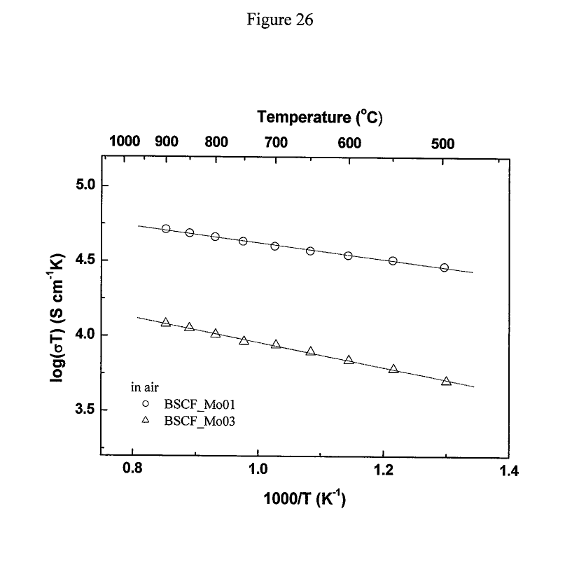

FIG. 26: Activation energy for the electrical conductivity of BSCF_Mo01 and BSCF_Mo03 in air;

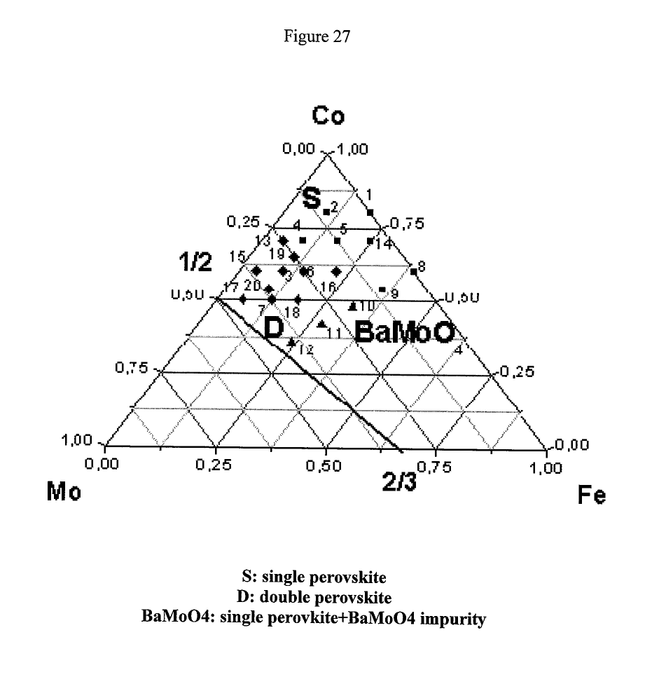

FIG. 27: Pseudo-phase diagram for a range of Ba_{0.5}Sr_{0.5}(Co_{0.8-x}Fe_{0.2-y}Mo_{x+y})O_{3-d} compositions;

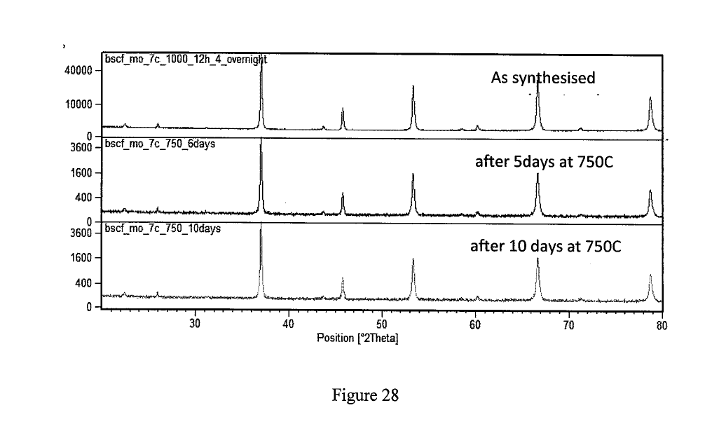

FIG. 28: PXRD measurements of BSCF-Mo0.375 after high temperature annealing;

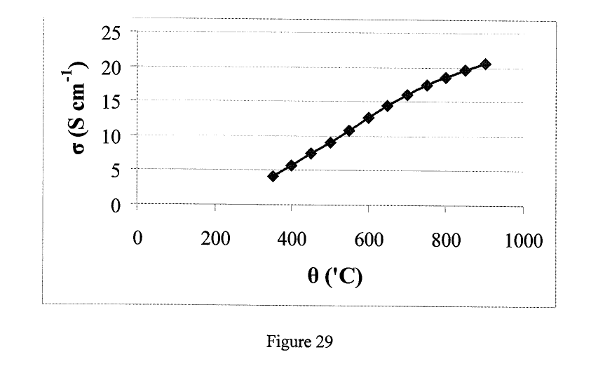

FIG. 29: Electrical characterization of BSCF-Mo0.375 by measurement of dc conductivity in air;

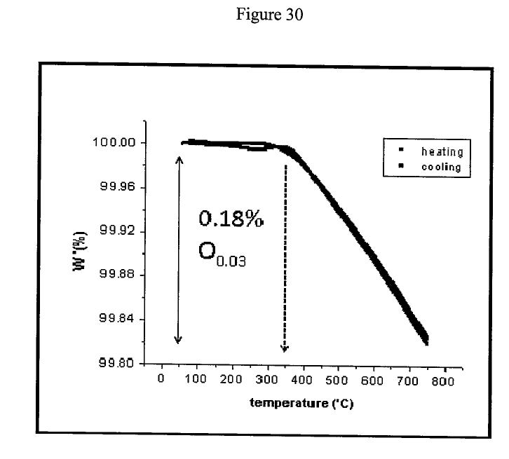

FIG. 30: TGA analysis of as-synthesized BSCF_Mo0.375 in air with a temperature rate 5° C./min for a heating-cooling cycle;

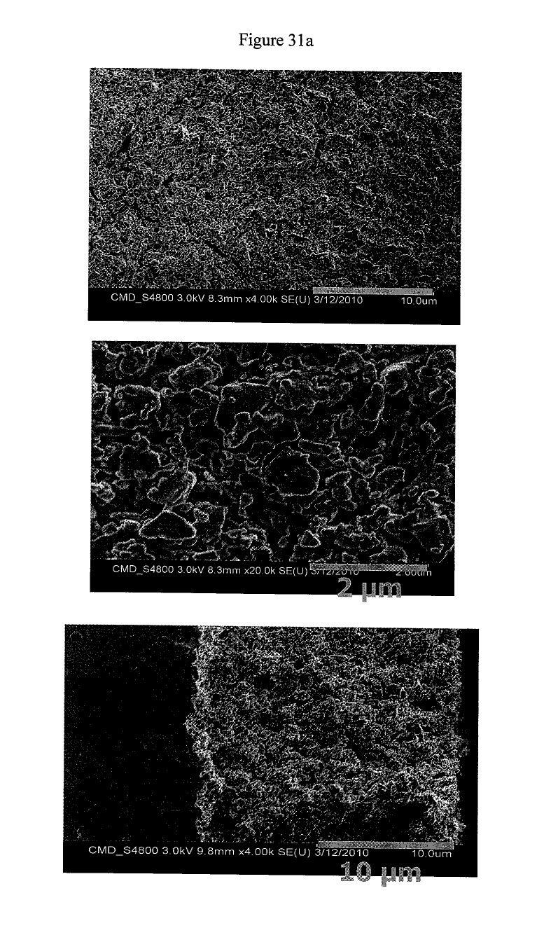

FIG. 31a: SEM images of a fractured symmetrical BSCF-Mo0.375/SDC/BSCF-Mo0.375 cell;

FIG. 31b: PXRD pattern of a 1:1 mixture of SDC-BSCF-Mo0.375 fired at 750° C./10 h (upper) compared with the PXRD pattern of the as-synthesised BSCF-Mo0.375;

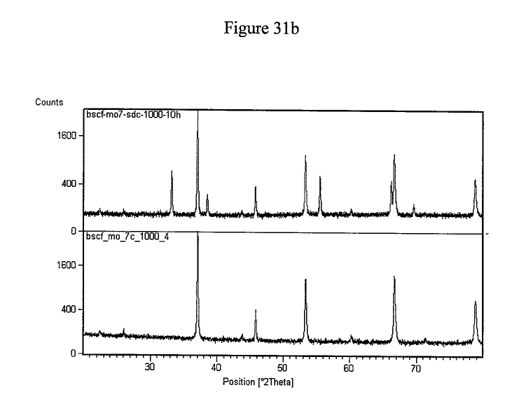

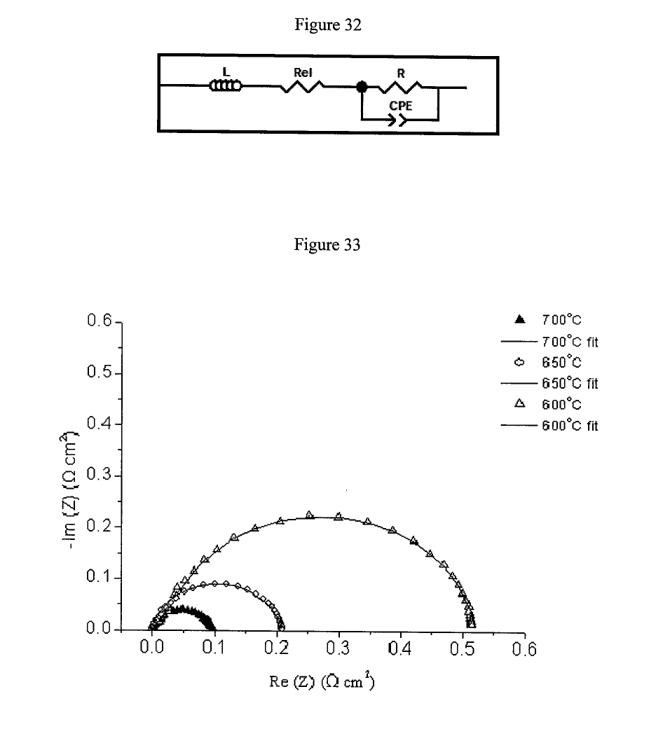

FIG. 32: Equivalent circuit for fitting impedance spectra of BSCF-Mo0.375/SDC/BSCF-Mo0.375;

FIG. 33: Fitting the impedance spectra of BSCF-Mo0.375/SDC/BSCF-Mo0.375 at various temperatures to the equivalent circuit shown in FIG. 32;

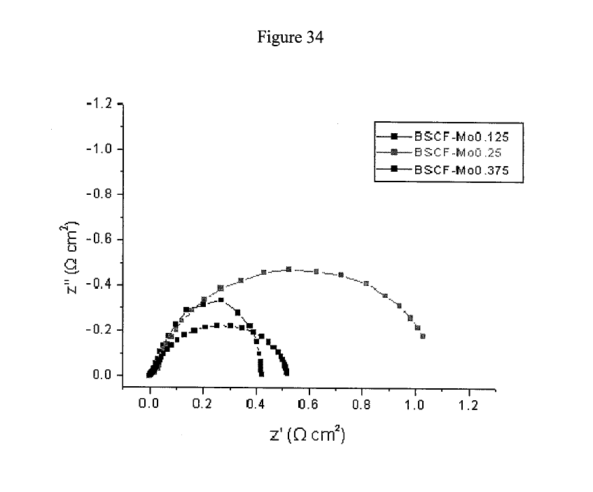

FIG. 34: ASR values at 600° C. for BSCF-Mo0.125, BSCF-Mo0.25 and BSCF-Mo0.375; and

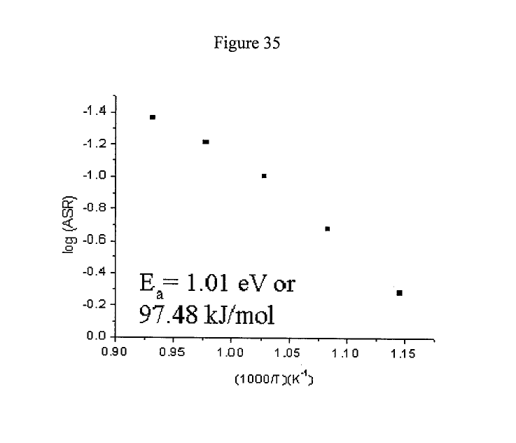

FIG. 35: Fit for calculating the activation energy for the oxygen reduction reaction.

### EXAMPLE 1

### Ba₂CoMo_{0.5}Nb_{0.5}O_{6-δ}

### Preparation of BCMN Samples

Ba₂CoMo_{0.5}Nb_{0.5}O_{6-δ} (BCMN) was prepared via a solid-state reaction method. Stoichiometric amounts of high purity (99.99%) BaCo₃, Co₃O₄, MoO₃ and Nb₂O₅ were mixed together by ball milling for 24 h with alcohol followed by drying, grinding and calcination at 700° C. for 6 h and at 900° C. for 8 h. The resulting powders were then ball milled again and isostatically pressed into pellets with an Autoclave Engineers Cold Isostatic Press under a pressure of 200 MPa and subsequently sintered in air at 1100° C. for 12 h. After confirming a single phase by XRD, the pellets were cut into bars for the electrical conductivity measurement with standard de four-probe method or crushed and ball milled again to produce powders for other characterization.

### Characterization of Structure

The structure of the materials was analyzed by powder X-ray diffraction (XRD) on a Panalytical X'pert Pro diffractometer (with Co radiation). Time-of-flight neutron diffraction (ND) data were collected with variable temperature from room temperature to 900° C. at an interval of 100° C. on the POLARIS at the ISIS facility, Rutherford Appleton Laboratories. The TEM study was carried out on JEOL JEM3010 (JEOL, LaB₆ filament, 300 keV) and EDS data were collected by EDAX analyzer equipped on JEM2000FX (JEOL, W filament, 200 keV). The atomic ratio of Ba, Co, Mo and Nb obtained from EDS is 2.02:1.01:0.48:0.49 which is close to the nominal formula Ba₂CoMo_{0.5}Nb_{0.5}O_{6-δ}. X-ray absorption near edge spectroscopy (XANES) was carried out in transmission mode in station 9.3 at the SRS synchrotron in the Daresbury Laboratory (Warrington, UK).

Chemical Compatibility with SDC and Long-Term Annealing

The phase composition of a mixture of BCMN or BSCF and SDC (Ce_{0.8}Sm_{0.2}O_{2-δ}) calcined at different temperatures was determined by XRD. Powders of BCMN or

BSCF and SDC with a weight ratio of 1:1 were well mixed, pressed into pellets and calcined at 1000° C. or 1050° C. for 5 h or 10 h. The pellets were then crushed to powders for XRD characterisation. For long-term structural stability tests, the as-synthesized powders of BCMN or BSCF with single-phase were annealed at 750° C. in air for 240 h and then used for XRD measurement. XRD patterns were taken from the powders obtained by calcination of as-purchased SDC powders (SDC20-M from fuelcellmaterials.com, surface area: 30-40 m²/g, particle size (d50): 0.3 to 0.5 μm) at 900° C. for 2 h.

### Symmetric Cells Fabrication and Testing

Ce_{0.8}Sm_{0.2}O_{2-δ} was first pressed into pellets and then sintered at 1400° C. for 8 h to obtain fully dense SDC electrolyte substrates (1.5 mm thick, 10 mm diameter). To prepare the electrode paste, BCMN powders were mixed by ball milling with an organic binder (Heraeus V006) and thinner (Heraeus RV372). The electrode pastes were applied to both surfaces of the SDC substrate by screen printing and then sintered in air at 1000° C. for 3 h. The thickness and diameter of the electrodes were about 30 μm and 10 mm respectively. The contacts for the electrical measurements were made using gold mesh fixed with gold paste. The impedance spectra of the symmetric cells were obtained under the air atmosphere with a flow rate of 100 ml/min in the range 550° C. to 800° C. using a Solartron 1260 frequency response analyzer coupled to a 1287 electrochemical interface and controlled by ZPlot electrochemical impedance software. The impedance spectra were analyzed with the Zview software (Scribner Associates, Inc.). The microstructure of the electrodes was investigated by scanning electron microscope (SEM, Hitachi S-4800).

### Results

XRD, ED and neutron diffraction (ND) data (FIGS. 1-3) show that BaCoMo_{0.5}Nb_{0.5}O_{6-δ} adopts a double perovskite structure A₂B′B″O₆ with A=Ba at the 8c site, B′=Co at the 4a site and B″=Mo/Nb at the 4b site at room and high temperatures (see Kobayashi, K. I et al. Nature 1998, 395, 677). The ND data were used to refine the oxygen content and the occupancy fraction for cations with the constraints of nominal compositions and identical atomic displacements value set for Mo and Nb. The B-site cationic antisite models were also examined by introducing Co/(Mo,Nb), Co/Mo, or Co/Nb disordering. EDS measurement has confirmed the atomic ratio of Ba, Co, Mo and Nb is 2.02:1.01:0.48:0.49.

As shown in FIGS. 1 and 11-13 and Tables 1 and S1-S3, the best refinement results come from the Co/(Mo,Nb) antisite with the formula Ba₂(Co₁₋ₓMo_{x/2}Nb_{x/2})(Mo_{0.5-x/2}Nb_{0.5-x/2}Coₓ)O_{6-δ} for room temperature and 900° C. data refinement with x=0.102 (χ²=1.57, R_{F}²=6.55%) at room temperature and x=0.070 cationic disordering (χ²=1.43, R_{F}²=14.23%). The total oxygen content from refinement is 5.87(7) and 5.70(2) for the sample at room temperature and 900° C. respectively (Table 1).

XANES spectra indicate a pure Nb⁵⁺ state in the material and a mixed oxidation state of +2/+3 for Co at room temperature (see FIG. 14). Quantitative analysis of XANES data by inflection point shift reveals a ratio of 70:30 for Co²⁺:Co³⁺ at room temperature (see Arcon, I. et al. J. Am. Ceram. Soc. 1998, 81, 222). The oxide chemistry of Mo together with charge balance considerations indicate the formation of Mo(VI) (see Deng, Z. Q. et al. Chem. Mater. 2008, 20, 6911). The oxygen content is calculated to be 5.90 which agrees well with the value obtained from neutron refinement (5.87(7)). The final refined structural results for BaCoMo_{0.5}Nb_{0.5}O_{6-δ} at room temperature and 900° C. are listed in Tables 1 and S1-S3. The change of oxygen content from ND refinement between room temperature and 900° C. is 0.17 per formula unit which is also comparable with the TGA result (0.14 per formula unit, see FIG. 2) which suggests the reduction of Co³⁺ to Co²⁺ at high temperatures. The formation of oxygen vacancies at high temperature is expected to afford oxide-ionic conductivity which is helpful to decrease the cathode ASR value for the oxygen reduction reaction. The reduction of Co³⁺ to Co²⁺ at high temperature might be partially responsible for the decreased oxygen content at 900° C. due to the bigger charge and/or ionic radius difference between Co²⁺ and Mo/Nb.

Transmission Electron Microscopy (TEM) studies were taken to analyse the local crystal structure. Selected Area Electron Diffraction (SAED) patterns of the sample are shown in FIG. 3 which consists of seven major diffraction patterns along the [001], [011], [012], [ 1̅11], [ 1̅33], [ 1̅12] and [ 1̅13] zone axes arranged according to their orientations in a basic orientation triangle. The SAED patterns confirmed that the oxide has a double perovskite cubic unit cell with lattice parameters a≈8.1 Å and the reflection conditions are the same as that of space group Fm 3̅m which suggest that the neighboring B sites are different (ie ordered). This is consistent with the overall structure proposed by XRD and ND studies. Many SAEDs along other zone axes and different grains were also taken and indexed and no extra weak diffractions or streaks were found in the SAED patterns. The consistency between the SAED and XRD results is the same as described above.

The B site cation ordering is further confirmed by High Resolution TEM (HRTEM) image along [112] zone axis—a direction from which the neighboring B sites can be readily separated (as shown in FIG. 4). It is visible that along [11 1̅] direction, the B layers are stacked with alternate black and white contrast which means the B sites are alternately occupied by different composition of B site cations. The HRTEM image simulation showed that darker B layers are occupied by Co while the brighter B layers are occupied by Mo/Nb. Substitutions to enhance the Co content further (Ba₂Co_{1.5}Mo_{0.25}Nb_{0.25}O_{6-δ} and BaCo_{0.9}Nb_{0.1}O_{3-δ}) produce multiple phase systems.

Shown in FIG. 5 are the electrical conductivity data measured in air over the temperature range 400-950° C. Ba₂CoMo_{0.5}Nb_{0.5}O_{6-δ} exhibits an electrical conductivity of 1.2 and 1.0 S/cm at 800 and 700° C. respectively with activation energy of 0.29 eV over the measured temperature range. FIG. 6 (a) shows a typical cross-sectional scanning electron microscope (SEM) image of the fractured electrolyte/electrode bi-layer fabricated by a screen-printing technique sintered at 1000° C. for 3 h. The BCMN electrode presents a required highly porous morphology with a homogeneous thickness of 28-30 μm (Au collector is also seen on the electrode top). It also indicates that the SDC electrolyte has a fully dense structure and good adhesion to electrode. A representative surface SEM image (see FIG. 6 (b)) reveals a uniform and porous electrode structure formed by oxide grains with average size ca. 500 nm and good inter-grain connection. More cross-section SEM images are given in FIG. 15.

Impedance spectroscopy measurements were performed on a symmetrical BCMN/SDC/BCMN cell in the temperature range 550° C.˜800° C. in air. FIG. 7 shows the representative EIS spectra for the cathode shown in FIG. 6. The difference between the low-frequency (LF) and the high-frequency (HF) intercepts on the real axis is taken as the area specific resistance (ASR). The measured values for pure BCMN cathode were 0.09, 0.20, 0.49 and 1.31 Ωcm² at 750, 700, 650 and 600° C. respectively. The ASR data for cathode materials depends strongly on the composition, morphology and processing parameters and on whether the cathode is single-phase or composite and on the interlayer application between electrode and electrolyte. For example at 600° C., the ASR value has been reported (see Tarancon, A et al. Power Sources 2007, 174, 255; Bellino, M. G et al. J. Am. Chem. Soc. 2007, 129, 3066; Grunbaum, N. et al. Solid State Ionics 2006, 177, 907; and Sahibzada, M. et al. Solid State Ionics 1998, 113-115, 285) as:
2.8 Ωcm² for GdBaCo₂O_{5+δ} (GBCO on YSZ)
1.15 Ωcm² for La_{0.6}Sr_{0.4}CoO_{3-δ} (LSC on SDC)
2.0 Ωcm² for Sm_{0.5}Sr_{0.5}CoO_{3-δ} (SSC on SDC)
1.3 Ωcm² for La_{0.6}Sr_{0.4}Co_{0.2}Fe_{0.8}O_{3-δ} (LSCF on Gd_{0.1}Ce_{0.9}O_{1.95})
0.1-1.1 Ωcm² for Ba_{0.5}Sr_{0.5}Co_{0.8}Fe_{0.2}O_{3-δ} (BSCF on SDC).

For a more direct comparison, a symmetric cell BSCF/SDC/BSCF was fabricated in a manner identical to that used for cells containing BCMN as the cathode in this Example (except that the cell was sintered at a slightly lower temperature of 970° C. for 3 h owing to reactions between BSCF and SDC as shown below). A value of 0.51 cm² was observed at 600° C. which is in good agreement with some prior reports (see Li, S. Yet al. J. Alloys and Compounds 2008, 448, 116). Thus BCMN possesses comparable electrochemical properties to most of the existing best cathode materials.

FIG. 8 shows the best fits of EIS data using the equivalent circuit shown in the inset where R₁ represents the ohmic resistance (note that this arc is not shown in the present data) and the R/CPE represent electrode processes (CPE is constant phase element) with two arcs. The fitted parameters of the impedance data including resistance, time constant and CPE exponent in the temperature range 600-750° C. are listed in Table S4. The R₁ observed in FIG. 8 yielded an ionic conductivity of 0.016 S cm⁻¹ at 600° C. At other points in the range 550-800° C., the conductivity values obtained in this way are in good agreement with reported values for SDC (see Eguchi, K et al. Solid State Ionics 1992, 52, 165).

FIG. 9 shows the temperature dependence of ASR(R_{LF}+R_{HF}) and the resistance of LF (R_{LF}) and HF arcs (R_{HF}) of the BCMN electrode. The activation energy of the LF and HF arc is found to be 147.9 and 112.1 kJ mol⁻¹, whilst that of the total cathode ASR is 130.0 kJ mol⁻¹ (being equal to the average of the above two values). This ASR activation energy for the oxygen reduction on BCMN cathode is comparable with that of BSCF 116-127.4 kJ mol⁻¹ and LSCF 131-138 kJ mol⁻¹ on SDC electrolyte in the same temperature range (see Shao [supra]; Esquirol, A et al, Solid State Ionics 2004, 175, 63). As shown in Table S4 and FIG. 8, the capacitance 1.1×10⁻²-5.7×10⁻² F cm⁻² and time constant values (τ=RC) 8.6×10⁻³-2.3×10⁻³ s at 650-750° C. accompanied by the high activation energy of 147.9 kJ mol⁻¹ for the LF arc are consistent with the characteristics associated with the dissociative adsorption and diffusion of oxygen on the surface of the electrode. The capacitance value is comparable with the following reported values (see Baumann, F. S. et al, J. Solid State Ionics 2006, 177, 1071; Jiang, S. P. Solid State Ionics 2002, 146, 1; Jiang, S. P et al. Journal of Power Sources 2002, 110, 201; and Chen, C. W. et al. Solid State Ionics 2008, 179, 330):
the dense LSCF microelectrode 15 mF cm⁻² (750° C.)
the porous LSCF electrode 3.6 mF cm⁻²,
the porous LSM electrode 12.2×10⁻³Ω⁻¹ cm⁻²sⁿ (n=0.7, 700° C.) and
the porous La_{0.74}Ca_{0.25}Co_{0.8}Fe_{0.2}O_{3-δ} 12.7×10⁻³Ω⁻¹ cm⁻²sⁿ (n=0.89, 750° C.)
   On the other hand, the HF arc with a capacitance lower by one order of magnitude than that of the LF arc and a typical time constant ˜10⁻⁴ s is likely to be related to the charge-transfer process (see Adler, S. B et al. J. Electrochem. Soc. 1996, 143, 3554; Shah, M.; Barnett, S. A. Solid State Ionics 2008, 179, 2059; and Dusastre, V.; Kilner, J. A.; Solid State Ionics 1999, 126, 163). For BCMN, the rate-limiting steps are the dissociative adsorption and diffusion at the BCMN electrode surface at low temperatures and the charge transfer process at high temperature when T>700° C. It is notable for BCMN that the surface kinetics impedance shows a comparable contribution to the charge-transfer impedance, in contrast with some materials such as LSC and LSCF in which the LF surface kinetics impedance is the predominant part of ASR (see Zhao, F et al. Mater. Res. Bull. 2008, 43, 370).

As shown in FIG. 8 and Table S4, BCMN has R_{LF} 0.78 Ωcm⁻² and R_{HF} 0.55 cm⁻² at 600° C. compared with R_{LF} 3.0 Ωcm⁻² and R_{HF} 1.0) cm⁻² reported for LSCF electrode at 590° C. and R_{LF} 1.6 Ωcm⁻² and R_{HF} 1.1 Ωcm⁻² (HF) for a LSC-SDC composite cathode (see Dusastre et al [supra] and Zhao et al [supra]). This reflects the low electrical conductivity of BCMN (ie 1.2 and 1.0 S/cm at 800 and 700° C. respectively) compared with 300-320 S/cm for LSCF and LSM at 750° C. (see Jiang [supra]; and Stevenson, J. W et al. J. Electrochem. Soc. 1996, 143, 2722). On the other hand, it also suggests that surface kinetics of BCMN could play an important role in good electrode performance for oxygen reduction reaction. This inference is supported by the fact that the activation energy for oxygen surface exchange for the BCMN electrode (˜147.9 kJ mol⁻¹) is lower than that of the porous LSM (202˜236 kJ mol⁻¹), the dense LSCF microelectrode (154.4 kJ mol⁻¹) and the dense BSCF microelectrode (173.7 kJ mol⁻¹) in the temperature range 600-750° C. (see Jiang [supra]; Jiang et al [supra]; and Baumann, F. S. et al. J. Electrochem. Soc. 2007, 154, B931). The reason for this finding remains unclear but one possible explanation may come from the additional catalytic activity of Mo which may promote the dissociation and surface diffusion of oxygen species on the cathode to the three-phase boundary (TPB) therefore improving the oxygen reduction reaction. Furthermore BCMN might have some oxygen ionic conductivity by oxygen vacancies at high temperatures which is also related to the good electrode performance.

In order to investigate the long-term stability of BCMN, the as-synthesized single-phase powders were annealed for an extended time (held at 750° C. for 240 h). For comparative purposes, Ba_{0.5}Sr_{0.5}Co_{0.8}Fe_{0.2}O_{3-δ} (BSCF) powders (synthesized at 1100° C./8 h and confirmed as single-phase by XRD) were annealed under the same conditions. As shown in FIG. 10, no significant changes in the XRD patterns before and after annealing were observed for BCMN (except peaks were shifted slightly to low degrees suggesting a small expansion of perovskite lattice probably due to oxygen loss during annealing). The refined cell parameters with XRD data are 8.1117(1) and 8.1148(1) Å for the as-synthesized and annealed samples respectively. In contrast, BSCF partially decomposes (see FIG. 16) suggesting much improved long-term stability for BCMN. The observations about structural instability of BSCF agree well with previous studies which show that BSCF separates into a mixture of hexagonal phase of barium-rich iron-free cobalt perovskite and cubic phase of strontium-rich, iron-cobalt perovskite (see Svaracova et al [supra]; Ovenstone, J et al. J. Solid State Chem. 2008, 181, 576; and Arnold, M et al. Chem. Mater. 2008, 20, 5851). The improved structural stability of BCMN may be linked to the peculiar structure where B-site cations are stacked in an ordered sequence owing to differences in ionic radii (Co²⁺=0.0745 nm (HS), Co²⁺=0.065 nm (LS), compared to Mo⁶⁺=0.059 nm, Nb⁵⁺=0.064 nm).

For cathode application of BCMN, the compatibility with a SDC electrolyte was also investigated. The reactivity tests between BCMN and SDC were carried out by co-firing a pressed pellet of BCMN and SDC (weight ratio of 1:1) at different temperatures. BSCF was also tested for comparison. As shown by the XRD data in FIG. 10, no new phases other than BCMN and SDC or obvious peaks shifts for the components were observed even after co-firing at 1050° C. for 10 h. This is an indication of the absence of solid-state reactions reaction between SDC and BCMN. The refined cell parameters for BCMN and SDC after reaction are 8.1187(2) and 5.4314(1) Å (5.4288(5) Å for starting SDC sample). However, the reaction using BSCF with SDC leads to obvious impurity phases produced even at a lower temperature of 1000° C. for 5 h (as shown in FIG. 16). For BCMN, the good chemical compatibility with SDC is also supported by ASR measurements on another symmetrical cell which was fabricated in the identical manner but sintered at 1050° C./3 h. No obvious change on the ASR values has been observed with a cell sintered at 1000° C./3 h. Although no obvious reaction with SDC was observed for BCMN, the compositions of both cathode and electrolyte may change due to diffusion of the ions, (as evidenced by XRD data in FIG. 10 showing peaks slightly broadening of (c) at 88.46 and 111.14° compared with those of (b)). Further studies including energy dispersive X-ray spectroscopy (EDX) indicated a slight interdiffusion of Co into SDC and Ce into BCMN on the interface (see FIG. 17).

### CONCLUSION

In the context of a potential SOFC cathode application, the present invention provides a new oxide Ba₂CoMo_{0.5}Nb_{0.5}O_{6-δ} (BCMN) with a B-site cation ordered double perovskite structure. The new material exhibits comparable electrochemical properties and much improved stability compared with existing oxides. From variable Polaris data, the calculated thermal expansion coefficient of BCMN is 16.0 ppm K⁻¹ which compares favourably with 27.3 ppm K⁻¹ for BSCF and 16.2 ppm K⁻¹ for La_{0.6}Sr_{0.4}Co_{0.2}Fe_{0.8}O_{3-δ} (see Ried, P et al. J. Electrochem. Soc. 2008, 155, B1029) but is higher than that of SDC (12.7 ppm K⁻¹) in the temperature range 20-900° C. Coupled with the limited ionic conductivity of BCMN, this means that additional reduction of cathode polarisation resistance is possible by the inclusion of an optimum amount of SDC to form a composite cathode. This alleviates the thermal mismatch between cathode and electrolyte to ensure better interfacial contact and expand the oxygen reduction area to the entire cathode surface.

TABLE 1
Refined structural parameters for Ba₂CoMo_{0.5}Nb_{0.5}O_{6-δ} from
ND data at room temperature (RT) and 900° C.

| Atom | RT | 900° C. |
|---|---|---|
| a/Å | 8.10728(6) | 8.22272(4) |
| Ba, 8c, 0.25, | 0.0055(2) | 0.0227(3) |
| 0.25, 0.25, | | |
| Uᵢₛₒ (Å²) | | |
| Co/(Mo, Nb), 4a, 0, 0, 0, | 0.0071(9) | 0.0246(14) |
| Uᵢₛₒ (Å²)^{a} | | |
| Occupancy | 0.897(12)/0.051(6)/ | 0.930(10)/0.035(5)/ |
| | 0.051(6) | 0.035(5) |
| Mo/Nb/Co^{a}, | 0.0031(3) | 0.0130(5) |
| 4b, 0.5, 0, 0, | | |
| Uᵢₛₒ (Å²)^{a} | | |
| Occupancy | 0.449(6)/0.449(6)/ | 0.465(5)/0.465(5)/ |
| | 0.102(12) | 0.070(10) |
| O, 24e, x, 0, 0 | 0.2579(2) | 0.2589(2) |
| Uₐₙᵢₛ (Å²)^{b} | | |
| U₁₁ | 0.0082(4) | 0.0175(5) |
| U₂₂ = U₃₃ | 0.0083(2) | 0.0321(3) |
| Occupancy | 0.979(5) | 0.950(4) |
| Oxygen content | O_{5.87(7)} | O_{5.70(2)} |
| per formula | | |
| χ²/R_{F}²(%) | 1.57/6.55 | 1.43/14.23 |

^{a}Uiso of mixed site atoms were constrained to be same value and refined simultaneously,
^{b}Uij = 0

TABLE S1
Co and Mo/Nb ordered

| Atom | RT | 900° C. |
|---|---|---|
| Ba, 8c, 0.25, | 0.0054(2) | 0.0226(3) |
| 0.25, 0.25, | | |
| Uᵢₛₒ (Å²) | | |
| Co, 4a, 0, 0, 0, | 0.0042(10) | 0.0195(12) |
| Uᵢₛₒ (Å²) | | |
| Mo/Nb^{a}, | 0.0041(4) | 0.0148(4) |
| 4b, 0.5, 0, 0, | | |
| Uᵢₛₒ (Å²)^{b} | | |
| O, 24e, x, 0, 0 | 0.2574(2) | 0.2587(2) |
| Uₐₙᵢₛ (Å²)^{c} | | |
| U₁₁ | 0.0086(5) | 0.0176(5) |
| U₂₂ = U₃₃ | 0.0083(2) | 0.0322(3) |
| Occupancy | 0.984(6) | 0.954(4) |
| Oxygen content | O_{5.90(8)} | O_{5.72(6)} |
| per formula | | |
| Rₚ(%)/R_{wp}(%)/χ²/R_{F}²(%) | 2.61/5.05/2.12/ | 1.10/2.59/1.45/ |
| | 6.97 | 14.50 |

^{a}Occupancy of Mo/Nb is set as 0.5/0.5,
^{b}Uᵢₛₒ of mixed site atoms were constrained to be same value and refined simultaneously,
^{c}Uᵢⱼ = 0

TABLE S2
Co/Nb antisite

| Atom | RT | 900° C. |
|---|---|---|
| Ba, 8c, 0.25, | 0.0055(2) | 0.0227(3) |
| 0.25, 0.25, | | |
| Uᵢₛₒ (Å²) | | |
| Co/Nb^{a}, 4a, 0, 0, 0, | 0.0071(9) | 0.0246(14) |
| Uᵢₛₒ (Å²)^{a} | | |
| Occupancy | 0.901(12)/0.099(12) | 0.932(9)/0.068(9) |
| Mo/Nb/Co^{a}, | 0.0031(3) | 0.0130(5) |
| 4b, 0.5, 0, 0, | | |
| Uᵢₛₒ (Å²)^{a} | | |
| Occupancy | 0.5/0.401(12)/ | 0.5/0.432(9)/ |
| | 0.099(12) | 0.068(9) |
| O, 24e, x, 0, 0 | 0.2579(2) | 0.2589(2) |
| Uₐₙᵢₛ (Å²)^{b} | | |
| U₁₁ | 0.0082(4) | 0.0175(5) |
| U₂₂ = U₃₃ | 0.0083(2) | 0.0321(3) |
| Occupancy | 0.979(5) | 0.950(4) |
| Oxygen content | O_{5.87(7)} | O_{5.70(2)} |
| per formula | | |
| Rₚ(%)/R_{wp}(%)/χ²/R_{F}²(%) | 2.24/4.85/1.57/ | 1.10/2.57/1.43/ |
| | 6.55 | 13.83 |

^{a}Uᵢₛₒ of mixed site atoms were constrained to be same value and refined simultaneously,
^{b}Uᵢⱼ = 0 better to use this line to quote the equivalent UisO

TABLE S3
Co/Mo antisite

| Atom | RT | 900° C. |
|---|---|---|
| Ba, 8c, 0.25, | 0.0054(2) | 0.0227(3) |
| 0.25, 0.25, | | |
| Uᵢₛₒ (Å²) | | |
| Co/Mo^{a}, 4a, 0, 0, 0, | 0.0071(9) | 0.0246(14) |
| Uᵢₛₒ (Å²) | | |
| Occupancy | 0.892(12)/0.108(13) | 0.927(10)/0.073(10) |
| Mo/Nb/Co^{a}, | 0.0030(3) | 0.0130(5) |
| 4b, 0.5, 0, 0, | | |
| Uᵢₛₒ (Å²)^{a} | | |
| Occupancy | 0.392(13)/0.5/ | 0.427(10)/0.5/ |
| | 0.108(13) | 0.073(10) |
| O, 24e, x, 0, 0 | 0.2579(2) | 0.2589(2) |
| Uₐₙᵢₛ (Å²)^{b} | | |
| U₁₁ | 0.0082(4) | 0.0175(5) |
| U₂₂ = U₃₃ | 0.0083(2) | 0.0321(3) |
| Occupancy | 0.979(5) | 0.950(4) |
| Oxygen content | O_{5.87(7)} | O_{5.70(2)} |
| per formula | | |
| Rₚ(%)/R_{wp}(%)/χ²/R_{F}²(%) | 2.27/4.85/1.60/ | 1.10/2.57/1.43/ |
| | 6.65 | 14.23 |

^{a}Uᵢₛₒ of mixed site atoms were constrained to be same value and refined simultaneously,
^{b}Uᵢⱼ = 0

TABLE S4
Impedance spectra fitting results for BCMN electrode

| | R_{LF} | | | R_{LF} × C_{LF} | R_{HF} | | | R_{HF} × C_{HF} |
|---|---|---|---|---|---|---|---|---|
| | (Ω cm²) | C_{LF} (F cm²) | n | (s) | (Ω cm⁻²) | C_{HF} (F cm²) | n | (s) |
| 600° C. | 0.78 | 1.1 × 10⁻² | 0.75 | 8.6 × 10⁻³ | 0.55 | 8.3 × 10⁻⁴ | 0.79 | 4.5 × 10⁻⁴ |
| 650° C. | 0.27 | 1.5 × 10⁻² | 0.76 | 4.1 × 10⁻³ | 0.22 | 1.3 × 10⁻³ | 0.77 | 3.1 × 10⁻⁴ |
| 700° C. | 0.10 | 3.0 × 10⁻² | 0.77 | 3.0 × 10⁻³ | 0.10 | 2.8 × 10⁻³ | 0.76 | 2.7 × 10⁻⁴ |
| 750° C. | 0.04 | 5.7 × 10⁻² | 0.62 | 2.3 × 10⁻³ | 0.06 | 8.9 × 10⁻³ | 0.80 | 4.9 × 10⁻⁴ |

Z_{CPE}=1/[T(jω)ⁿ], where T is the proportional factor, j is the imaginary number, ω is the angular frequency. The capacitance value is calculated from (T/R⁽ⁿ⁻¹⁾)^{1/n}, R is the parallel resistance (Chen [supra]).

### EXAMPLE 2

### Mo Doped Barium Cobaltite Perovskites

The following Mo-doped barium cobaltite perovskites were tested as cathode materials (eg for polarisation resistance).

Ba_{0.5}Sr_{0.5}Co_{0.8}Fe_{0.1}Mo_{0.1}O_{3-δ} (designated as BSCF_Mo01)
Ba_{0.5}Sr_{0.5}Co_{0.6}Fe_{0.1}Mo_{0.3}O_{3-δ} (designated as BSCF_Mo03)
Ba_{0.5}Sr_{0.5}Co_{0.8}Fe_{0.2}O_{3-δ} (BSCF) is referred to for comparative purposes.

BSCF_Mo01 and BSCF_Mo03 were synthesized by solid-state reaction at 1100° C./8 h and 1050° C./24 h respectively. XRD data in FIG. 18 show that the BSCF_Mo01 and BSCF_Mo03 system adopt a single and double perovskite structure with a cell parameter of 3.9799(1) Å (Pm-3m) for BSCF_Mo01 and 7.9888(5) Å (Fm-3m) for BSCF_Mo03.

Shown in FIG. 19 are electrical conductivity data measured in air over the temperature range 450 to 900° C. BSCF_Mo01 exhibits an electrical conductivity of 43.8 S/cm at 800° C. and 39.8 S/cm at 600° C. BSCF_Mo03 exhibits an electrical conductivity of 9.5 S/cm at 800° C. and 7.5 S/cm at 600° C. The activation energy is 0.11 eV for BSCF_Mo01 and 0.13 eV for BSCF_Mo03 over the measurement range (see FIG. 25). For a comparison, BSCF has an electrical conductivity of 41.8 S/cm at 800° C. and 42.9 S/cm at 600° C.

FIG. 20 shows the TGA results which were obtained by two heating-cooling cycles in air at a temperature rate 5° C./min. After the first heating run, BSCF_Mo01 and BSCF_Mo03 show reproducible oxygen exchange upon heating-cooling cycles within the temperature range 300-900° C. The oxygen loss was 1.45% (O_{0.20}) for BSCF_Mo01 and 0.48% (O_{0.07}) for BSCF_Mo03 from the second cycle between 300° C. and 900° C. The reversible oxygen change could be related to the interesting SOFC cathode performance of these Mo-doping materials. On the other hand, the BSCF system shows irreversible oxygen exchange during heating-cooling cycles as shown in FIG. 25.

FIG. 21 compares the polarization properties of BSCF_Mo01, BSCF_Mo03 and BSCF. The symmetrical cells (oxide|SDC|oxide where SDC is Ce_{0.8}Sm_{0.2}O_{2-δ}) were fabricated by a screen-printing technique in a strictly controlled manner identical to that used for different materials to minimize the effect of fabrication methods and highlight the intrinsic difference between materials.

TABLE S5
Impedance spectra fitting results for BCCF_Mo03 electrode

| | R_{LF} | | | R_{LF} × C_{LF} | R_{HF} | | | R_{HF} × C_{HF} |
|---|---|---|---|---|---|---|---|---|
| | (Ω cm²) | C_{LF} (F cm²) | n | (s) | (Ω cm⁻²) | C_{HF} (F cm²) | n | (s) |
| 550° C. | 0.52 | 8.8 × 10⁻² | 0.86 | 4.6 × 10⁻² | 0.37 | 7.4 × 10⁻³ | 0.54 | 2.8 × 10⁻³ |
| 600° C. | 0.20 | 6.9 × 10⁻² | 0.83 | 1.4 × 10⁻² | 0.16 | 4.7 × 10⁻³ | 0.58 | 7.5 × 10⁻⁴ |

Z_{CPE}=1/[T(jω)ⁿ], where T is the proportional factor, j is the imaginary number, co is the angular frequency. The capacitance value is calculated from (T/R⁽ⁿ⁻¹⁾)^{1/n}, R is the parallel resistance

FIGS. 21 and 22 show the representative EIS spectra for the cathode. The difference between the low-frequency (LF) and the high-frequency (HF) intercepts on the real axis is taken as the area specific resistance (ASR). The best performance was obtained on a symmetrical cell containing BSCF_Mo03 cathode with SDC interlayer between cathode and electrolyte (ie the measured ASR values were 0.04, 0.07, 0.16, 0.35 and 0.89 Ωcm² at 750, 700, 650 600 and 550° C. respectively). BSCF on SDC has been reported to have the best cathode performance among existing materials. For a more direct comparison, a symmetric cell BSCF/SDC/BSCF was fabricated in a manner identical to that used for cells containing Mo-doping materials. From FIG. 21 it can be seen that Mo-doping has a beneficial effect to enhance the cathode performance at low temperatures (ie by lowering resistance).

FIG. 22 shows the best fits of EIS data using the equivalent circuit shown in the inset (where R₁ represents the ohmic resistance (this arc is not shown in the present data) and the R/CPE represent electrode processes (CPE is a constant phase element) with two arcs at LF and HF). The fitted parameters of the impedance data including resistance, time constant and CPE exponent at 600 and 550° C. are listed in Table S5. The R₁ observed in FIG. 22 yielded an ionic conductivity of 0.016 S cm⁻¹ at 600° C. At other points from 550-800° C., the conductivity values obtained in this way are all in good agreement with reported values for SDC. As shown in Table S5 and FIG. 22, the capacitance and time constant values (τ=RC) at 600 and 550° C. suggest that the low-frequency (LF) and the high-frequency (HF) are associated with the electrode surface (dissociative adsorption and diffusion of oxygen) and the charge-transfer process.

FIG. 23 shows the measured area specific resistance (ASR) values for BSCF_Mo01, BSCF_Mo03 and BSCF. BSCF_Mo01 shows comparable ASR values at high temperature and lower values at low temperatures than that of BSCF. The present materials show good cathode performance. For example, for a symmetric cell BSCF_Mo03/SDC/BSCF_Mo03 with a porous SDC interlayer between electrode and electrolyte, the ASR values were 0.08, 0.16, 0.35, 0.88 and 2.63 Ωcm² at 700, 650, 600, 550 and 500° C. respectively. These values are among the best results reported in the literature for SOFC cathodes.

FIG. 24 compares the temperature dependence of ASR for BSCF_Mo01, BSCF_Mo03 and BSCF. A transition was observed in the BSCF system which is explained in term of bulk diffusion control at high temperatures and surface exchange control at low temperature or phase transition between high-temperature cubic perovskite structure and low-temperature structure. Mo doping is beneficial to either enhance the surface exchange kinetics of the material or suppress the phase transition encountered in the BSCF system.

### EXAMPLE 3

### Ba_{0.5}Sr_{0.5}Co_{0.8-x}Mo_{x+y}Fe_{0.2-y}O_{3-δ} as Cathode Materials for Solid Oxide Fuel Cells

### Experimental

Ba_{0.5}Sr_{0.5}Co_{0.8-x}Fe_{0.2-y}Mo_{x+y}O_{3-d} samples were prepared via a solid-state reaction. Stoichiometric amounts of high purity (99.99%) BaCo₃, SrCO₃, Co₃O₄, Fe₂O₃ and MoO₃ were mixed together with isopropanol by ball milling for 24 h. This was followed by drying, grinding and calcinations at 700° C. for 6 h and at 900° C. for 8 h. The resulting powders were ball milled again for 18 h with isopropanol and then dried, ground, pressed into pellets and subsequently sintered in air at a temperature in the range 950° C.-1000° C. (depending on the composition) for 48 h with four intermediate regrindings.

After phase identification by PXRD, the powder was pressed into pellets with an Autoclave Engineers Cold Isostatic Press at a pressure of 200 MPa to achieve a density of about 90%. The pellets were cut into bars for electrical conductivity measurements with a standard dc four-probe method in which Pt paste and Pt wires were used to make the four probes with four-in-a-line contact geometry.

A fully dense SDC electrolyte substrate (1.0 mm thick, 10 mm diameter) was obtained by pressing powder into pellets Ce_{0.8}Sm_{0.2}O_{2-d} (SDC from FuelcellMaterials.com) and sintering at 1400° C. for 8 h. For symmetrical cell testing, Mo-BSCF powders were mixed by ball-milling with an organic binder (Heraeus V006) to produce an electrode paste which was then applied onto both surfaces of the SDC electrolyte substrate by screen printing and sintered in air for 3 h at a temperature in the range 900-1000° C. (depending on the composition). The thickness and diameter were about 30 μm and 10 mm respectively. The contacts for the electrical measurement were made using gold gauze fixed with some gold paste.

For testing chemical compatibility with the electrolyte, powders of as-synthesised Mo-BSCF and SDC with a weight ratio 1:1 were well mixed, pressed into pellets and calcined at 1000° C. for 10 h. The pellets were then crushed to powder for PXRD characterization.

For long-term structural stability tests, the as-synthesised powders were annealed at 750° C. in air for 120 and 240 h and then characterized by PXRD.

### Compositions and Stability

A range of Ba_{0.5}Sr_{0.5}(Co_{0.8-x}Fe_{0.2-y}Mo_{x+y})O_{3-d} compositions was studied according to the pseudo-phase diagram shown in FIG. 27 in order to choose the compositions for more detailed study. These B-site compositions are listed in Table 6.

TABLE 6

| | Fe | Co | Mo |
|---|---|---|---|
| 1 | 0.2 | 0.8 | 0 |
| 2 | 0.1 | 0.8 | 0.1 |
| 3 | 0.1 | 0.6 | 0.3 |
| 4 | 0.1 | 0.7 | 0.2 |
| 5 | 0.175 | 0.7 | 0.125 |
| 6 | 0.15 | 0.6 | 0.25 |
| 7 | 0.125 | 0.5 | 0.375 |
| 8 | 0.4 | 0.6 | 0 |
| 9 | 0.36 | 0.54 | 0.1 |
| 10 | 0.32 | 0.48 | 0.2 |
| 11 | 0.28 | 0.42 | 0.3 |
| 12 | 0.24 | 0.36 | 0.4 |
| 13 | 0.05 | 0.7 | 0.25 |
| 14 | 0.25 | 0.7 | 0.05 |
| 15 | 0.04 | 0.6 | 0.36 |
| 16 | 0.22 | 0.6 | 0.18 |
| 17 | 0.06 | 0.5 | 0.44 |
| 18 | 0.184 | 0.5 | 0.316 |
| 19 | 0.1 | 0.65 | 0.25 |
| 20 | 0.1 | 0.54 | 0.36 |

The expected inhomogeneity was observed in these compositions. Three regions were clearly identified. When moving on a line with a Co:Fe ratio of 4 as in Ba_{0.5}Sr_{0.5}Co_{0.8}Fe_{0.2}O_{3-d}(see point 1), doping with a small amount of Mo (x+y=0.125 see point 5) gives a simple perovskite structure. Introduction of a greater amount of Mo (x+y=0.25 see point 6) resulted in the formation of a double perovskite structure with split peaks which is evidence of some simple perovskite formation as confirmed by PXRD. With increasing Mo content (x+y=0.375 see point 7), the fit of the PXRD patterns is in good agreement with double perovskite formation. Hence the Mo content is crucial in adopting a simple or double perovskite structure. Moving from point 7 to a lower Fe/Mo ratio than 3 but keeping Co content constant at 0.5, BaMoO₄ impurity is formed (see point 10: Fe/Mo=0.66) and simple perovskite is the main phase. Hence the Co/Fe ratio is an important factor and the formation of double perovskite is favoured when the Co/Fe ratio is 4 (see point 7). The introduction of more Mo whilst keeping the Co/Fe ratio constant at 0.6 leads to the formation of simple perovskite and BaMoO₄ impurity (see points 11 and 12 compared with point 10).

The compositions selected for further investigation were prepared via a combination of traditional solid state synthesis and ball-milling as described above and the compositions were confirmed by EDS.

The long term stability of compositions with a Co:Fe ratio of 4 such as BSCF (Ba_{0.5}Sr_{0.5}Co_{0.8}Fe_{0.2}O_{3-d} see point 1), BSCF-Mo0.125 (Ba_{0.5}Sr_{0.5}Co_{0.7}Fe_{0.175}Mo_{0.125}O_{3-d} see point 5 which adopts the simple perovskite structure) and BSCF-Mo0.375 (Ba_{0.5}Sr_{0.5}Co_{0.5}Fe_{0.125}Mo_{0.375}O_{3-d} see point 7 which adopts the double perovskite structure) was investigated. After annealing at 750° C. for 120 h and 240 h, PXRD showed that BSCF-Mo0.125 is separated into a mixture of a hexagonal phase of barium-rich iron-free cobalt perovskite and a cubic phase of strontium-rich iron-cobalt perovskite. For BSCF-Mo0.375, there is no change in the PXRD pattern as the B-site ordering enhances stability (see FIG. 28).

### Electrical Characterization—dc Conductivity (in Air)

Four-probe dc electrical conductivity data were measured in air in the temperature range 450-900° C. in 50° C. steps. BSCF-Mo0.375 exhibited an electrical conductivity of 18.5 Scm⁻¹ and 12.6 Scm⁻¹ at 800° C. and 600° C. respectively over the measured temperature range (see FIG. 29). For comparison, the electrical conductivity for BSCF measured under the same conditions is 38-43 S cm⁻¹ over 800° C. to 600° C. which suggests that the overall concentration of charge carriers is reduced by introducing d0 MoVI.

There was no clear dependence of dc conductivity at 700° C. on the pO2 under the measured oxygen partial pressure range 10⁰-10⁻¹³ atm. This showed that the oxygen content remains constant. Thus the increased stability of BSCF-Mo0.375 is not only observed in air but over a wide range of oxygen partial pressures which confirms the stabilizing effect of Mo.

### TGA

During initial heating in air at about 400° C., the sample of BSCF-Mo0.375 did not exhibit any significant weight changes. During continued heating from 400 to 750° C. at 5° C./min (see FIG. 30), oxygen loss was 0.18% (O_{0.03}) suggesting that there is a very small change in the number of oxygen carriers in that temperature range. BSCF is reported to lose about 0.8% oxygen during heating at 750° C.

Cooling the samples to 400° C. at 5° C./min resulted in a reproducible weight gain. A very small hysteresis was observed which was most probably due to O₂ adsorption kinetics in the sample. The oxygen vacancy concentration froze at 400° C. and further cooling did not result in significant weight change. After the initial heat up, the TGA curves showed good reproducibility as the powder was thermally cycled indicating that the powder was able to equilibrate with its surroundings (gaining or losing oxygen) on the time scale of the measurement.

### Electrochemical Characterization

Typical cross-sectional SEM images of a fractured symmetrical cell fabricated by screen-printing and sintered at 1000° C. for 3 h demonstrated the electrolyte/electrode bilayer (see FIG. 31a). The electrode layer had a porous structure in contrast with the dense SDC electrolyte and there was good adhesion. A representative surface SEM image revealed a uniform and porous electrode structure. According to the PXRD patterns, there was no undesirable solid state reactions between Mo-BSCF and SDC electrolyte for the 1:1 mixture in weight sintered in air at 1000° C. for 10 h (see FIG. 31b).

Impedance spectra of BSCF-Mo0.375 measured in air over the temperature range 600-800° C. in 50° C. steps were fitted by ZView 2.3 software using the equivalent circuit shown in FIG. 32. In the equivalent circuit, L is an inductance caused by the cables, the first resistance Rel corresponds to the ohmic resistance of the electrolyte and the R-CPE circuit is the cathode response (where R is the cathode polarization resistance and CPE represents the effect of inhomogeneity).

For the fitting of the Nyquist plot at 600° C., a second R-CPE element was added for the fitting of an additional small arc at high frequency in order to minimize errors. The polarization resistance of the cathode decreased with increasing temperature. ASR values of 0.52, 0.21, 0.09, 0.06 and 0.04 Ωcm² were observed for BSCF-Mo0.375 at 600° C., 650° C., 700° C., 750° C. and 800° C. respectively (see FIG. 33). For comparative purposes, FIG. 34 illustrates the ASR values at 600° C. for BSCF-Mo0.125, BSCF-Mo0.25 and BSCF-Mo0.375.

The ASR of another B-site ordered perovskite BCMN (Ba₂CoMo_{0.5}Nb_{0.5}O_{6-d}) on SDC was 1.31 Ωcm² at 600° C. (see Example 1). Other attempts at B-site doping of BSCF gave ASRs on SDC for Ba_{0.5}Sr_{0.5}(Co_{0.6}Zr_{0.2})Fe_{0.2}O_{3-d} of 0.58 Ωcm² at 600° C. (see Meng et al Materials Research Bulletin 44 (2009) 1293) and for Ba_{0.5}Sr_{0.5}Zn_{0.2}Fe_{0.8}O_{3-d} of 1.06 Ωcm² at 600° C. (see Wei, B et al. Journal of Power Sources 176 (2008), 1; and Zhou, W et al. Journal of Power Sources 192 (2009), 231). The reported values for BSCF are 0.055-0.071 Ωcm² at 600° C. (see Shao [supra]) which is lower by an order of magnitude. The literature shows that the ASR for cathode materials depends strongly on the microstructure and processing parameters. Since the microstructure has not been optimized and for a more direct comparison, the ASR of a symmetrical cell BSCF/SDC/BSCF fabricated by an identical procedure to that described above for Mo-BSCF but fired at a slightly lower temperature of 970° C. for 3 h was found to be 0.6 Ωcm² at 600° C.

In order to probe the electrode mechanism, the dependence of the electrode polarization resistance over an oxygen partial pressure of 0.16-0.75 atm at 700° C. was studied. The reaction order m determined from the slope of the R-pO2 plot was about 0.3 indicating that charge transfer is rate-limiting. In addition, the capacitance value of 10⁻³ F cm² and the time constant values (τ=RC) of 10⁻³ s at 650-700° C. were consistent with the characteristics associated with dissociative adsorption and incorporation of oxygen on the surface of the electrode. Hence the charge transfer process is the rate limiting step which controls the cathode reaction rate. The small arc at frequency 10⁻² of the Nyquist plot at 600° C. has a capacitance value one order of magnitude lower than the LF arc and a typical time constant of 10⁻⁴s. This is likely to be associated with transport of oxygen ions across the electrolyte electrode interface which is slower at lower temperatures.

The activation energy for the oxygen reduction reaction calculated from the slope of the fitted line (see FIG. 35) was found to be 97 kJ/mol which is lower than that of BSCF (116-127.4 kJ/mol—see Shao [supra]) and LSCF (131-138 kJ/mol—see Esquirol, A et al; Solid State Ionics 175 (2004), 63) on a SDC electrolyte in the same temperature range. BSCF cathode fabricated under the same conditions had an activation energy of 121.7 kJ/mol which is higher than that for BSCF-Mo0.375. When compared with other B-site ordered perovskites such as BCMN on SDC in the same temperature range, the activation energy of 130 kJ/mol is higher than that calculated for Mo-BSCF. B-site doped BSCF structures such as Ba_{0.5}Sr_{0.5}(Co_{0.6}Zr_{0.2})Fe_{0.2}O_{3-d} (see Meng [supra]) and Ba_{0.5}Sr_{0.5}Zn_{0.2}Fe_{0.8}O_{3-d} (see Wei [supra] and Zhou [supra]) show activation energies of 114.45 kJ/mol and 112.9±1.3 kJ/mol respectively for the oxygen reduction reaction which is higher than that of Mo-BSCF.

When decreasing the Mo content to 0.25 but keeping the Co:Fe ratio constant (BSCF-Mo0.25: see point 6) the electrode polarization resistance is almost doubled. When decreasing the Mo content further to 0.125 (BSCF-Mo0.125: see point 5), the formation of simple perovskite is favoured and the ASR is about 0.4 Ωcm². This shows that introducing Mo into BSCF enhances the oxygen reduction reaction. The corresponding activation energies are 115.79 kJ/mol and 125.24 kJ/mol for BSCF-Mo0.125 and BSCF-Mo0.25 respectively.

1. A cathode composed of a mixed metal oxide exhibiting perovskite-type and/or fluorite-type structural characteristics which has an empirical formula unit:
E_{A}T_{B}Mo_{C}Oₙ
wherein:
T is one or more transition metal elements other than Mo;
E is one or more metal elements selected from the group consisting of lanthanide metal elements, alkali metal elements, alkaline earth metal elements, Pb and Bi; and
A, B, C and n are non-zero numerals which may be the same or different for each element.

2. A cathode as claimed in claim 1 wherein the mixed metal oxide has an empirical formula unit:
(E′_{A′}E″_{A″})T_{B}Mo_{C}Oₙ
wherein:
E′ is Ba, Sr or a lanthanide metal element;
E″ is Ba, Ca or Sr;
T is one or more transition metal elements selected from the group consisting of Co, Nb, Mn, V, Fe and Ni; and
A′, A″, B, C and n are non-zero numerals which may be the same or different for each element.

3. A cathode as claimed in claim 2 wherein the mixed metal oxide has a structural unit of formula:
(E′₁₋ₓE″ₓ)(T_{1-y-v}Fe_{y-z})Mo_{v+z}O_{3-δ}
wherein:
0<x<1;
0≦y≦1;
0<v+z<1;
E′ is Ba or a lanthanide metal element;
E″ is Sr or Ca; and
T is one or more transition metal elements selected from the group consisting of Co, V or Mn.

4. A cathode as claimed in claim 2 wherein the mixed metal oxide has a structural unit of formula:
LaSr₃((Co_{1-y-v}Fe_{y-z})(Mo₁₋ₓNbₓ)_{v+z})₃O_{10-δ}
wherein:
0≦y≦1;
0≦x<1; and
0<v+z<1.

5. A cathode as claimed in claim 1 wherein the mixed metal oxide has a structuctural unit of formula:
(E′₂₋ₓE″ₓ)T_{1-z}Mo_{z}O_{4+δ}
wherein:
0≦x≦1;
0<z<1;
E′ is a lanthanide metal element; and
E″ is Sr or Ba.

6. A cathode as claimed in claim 1 wherein the mixed metal oxide has a structural unit of formula:
(E′_{A′}E″_{A″})(Co_{1-z}(Mo_{1-y}Nb_{y})_{z})₂O_{5+δ}
wherein:
0<z<1;
0≦y<1;
A′ and A″ are non-zero numerals which may be the same or different for each element;
E′ is a lanthanide metal element; and
E″ is Ba, Ca, Sr or a lanthanide metal element.

7. A cathode as claimed in claim 1 wherein the mixed metal oxide exhibits perovskite-type structural characteristics.

8. A cathode as claimed in claim 7 wherein the perovskite-type structural characteristics are attributable to a perovskite or double perovskite structure.

9. A cathode as claimed in claim 1 wherein the mixed metal oxide exhibits perovskite-type structural characteristics in which Mo occupies octahedral sites.

10. A cathode as claimed in claim 1 wherein the mixed metal oxide exhibits perovskite-type structural characteristics in which Mo occupies tetrahedral sites.

11. A cathode as claimed in claim 10 wherein the mixed metal oxide has a structural unit of formula:
E₂(T_{1-z}Mo_{z})₂O₅
wherein:
0<z<1;
E is one or more elements selected from the group consisting of lanthanide metal elements, Sr, Ca and Ba; and
T is one or more of the group consisting of Fe and Co.

12. A cathode as claimed in claim 1 wherein the mixed metal oxide has a structural unit of formula:
(E′₂₋ₓE″ₓ)(Co_{1-z}(Mo1_{-y}Nb_{y})_{z})₂O_{6-δ}
wherein:
0≦x≦1;
0≦y<1;
0<z<1;
E′ is Sr or Ba; and
E″ is a lanthanide metal element.

13. A cathode as claimed in claim 1 wherein the mixed metal oxide has a structural unit of formula:
Sr₄(Fe_{1-x-z}Coₓ(Mo_{1-y}Nb_{y})_{z})₆O₁₃
wherein:
o<z<1;
0≦y<1; and
0≦x≦1.

14. A cathode as claimed in claim 1 wherein the mixed metal oxide exhibits fluorite-type structural characteristics.

15. A cathode as claimed in claim 14 wherein the fluorite-type structural characteristics are attributed to a fluorite or pyrochlore structure.

16. A composition comprising:
a mixed metal oxide as defined in claim 1; and
an oxide ion or electronic conductivity promoter.

17. A composite comprising:
a mixed metal oxide as defined in claim 1; and
a stabilising ceramic.

18. A solid oxide fuel cell comprising a cathode as defined in claim 1, an anode and an oxygen-ion conducting electrolyte.
